(19) United States
(12) Patent Application Publication
(10) Pub. No.: US 2020/0326043 A1
(43) Pub. Date: Oct. 15, 2020

(54) REMOTE OPTICAL PUMPING OF LUMINESCENT CONCENTRATION RODS

(71) Applicant: PHILIPS LIGHTING HOLDING B.V., EINDHOVEN (NL)

(72) Inventors: Dirk Kornelis Gerhardus DE BOER, EINDHOVEN (NL); Johannes Joseph Hubertina Barbara SCHLEIPEN, EINDHOVEN (NL); Albert BIJLSMA, EINDHOVEN (NL); Hendrik Johannes Boudewijn JAGT, EINDHOVEN (NL); Gerardus Everardus Marie HANNEN, EINDHOVEN (NL)

(21) Appl. No.: 16/305,466

(22) PCT Filed: May 29, 2017
(86) PCT No.: PCT/EP2017/062846

§ 371 Date: Nov. 29, 2018

(30) Foreign Application Priority Data
Jun. 2, 2016 (EP) 16172652.6

(51) Int. Cl. F21K 9/68; F21K 9/64; F21V 29/50; F21V 7/06; F21K 9/61; F21V 8/00

(52) U.S. Cl. CPC F21K 9/68; F21K 9/64; F21V 29/50; F21V 7/06; F21W 2131/406; G02B 6/0003; G02B 6/0006; G02B 6/0008; F21K 9/61

(57) ABSTRACT

The invention provides a lighting device (1) comprising: —a luminescent concentrator (5) comprising an elongated light transmissive body (100) having a first face (141) and a second face (142) defining a length (L) of the light transmissive body (100), the light transmissive body (100) comprising one or more radiation input faces (111) and a radiation exit window (112), wherein the second face (142) comprises said radiation exit window (112); the elongated light transmissive body (100) comprising a luminescent material (120) configured to convert at least part of light source light (11) received at one or more radiation input faces (111) into luminescent material light (8), and the luminescent concentrator (5) configured to couple at least part of the luminescent material light (8) out at the radiation exit window (112) as converter light (101); —a light source mirror unit (200) comprising: —a plurality of light sources (10) configured to provide said light source light (11) in a direction of a curved mirror (220); —said curved mirror (220), configured to collect at least part of said light source light (11) and configured to redirect the collected light source light (11) to at least one of the one or more the radiation input faces (111) of the luminescent concentrator (5)

### FIELD OF THE INVENTION

The invention relates to a lighting device, such as for use in a projector or for use in stage lighting.

### BACKGROUND OF THE INVENTION

Luminescent rods are known in the art. WO2006/054203, for instance, describes a light emitting device comprising at least one LED which emits light in the wavelength range of >220 nm to <550 nm and at least one conversion structure placed towards the at least one LED without optical contact, which converts at least partly the light from the at least one LED to light in the wavelength range of >300 nm to <1000 nm, characterized in that the at least one conversion structure has a refractive index n of >1.5 and <3 and the ratio A:E is >2:1 and <50000:1, where A and E are defined as follows: the at least one conversion structure comprises at least one entrance surface, where light emitted by the at least one LED can enter the conversion structure and at least one exit surface, where light can exit the at least one conversion structure, each of the at least one entrance surfaces having an entrance surface area, the entrance surface area(s) being numbered A₁ . . . Aₙ and each of the at least one exit surface(s) having an exit surface area, the exit surface area(s) being numbered E₁ . . . Eₙ and the sum of each of the at least one entrance surface(s) area(s) A being A=A₁+A₂ . . . +Aₙ and the sum of each of the at least one exit surface(s) area(s) E being E=E₁+E₂ . . . +Eₙ.

WO2014/177457 A1 describes an SSL lighting device comprising a housing, which has a reflective inner surface, and an elongated light guide which includes a wavelength converting material for converting light in a first wavelength range to light in a second wavelength range. The elongated light guide comprises two ends, a portion for receiving light and a portion for emitting light. The portion for receiving light is arranged inside the housing and the portion for emitting light is arranged outside the housing and at least one of the two ends forms the portion for emitting light. The SSL lighting device also comprises a plurality of SSL light sources arranged inside the housing at a distance from the elongated light guide. A part of the light emitted from the plurality of SSL light sources into the housing enters the light guide via the portion for receiving light and is absorbed and converted by the wavelength converting material. By enclosing the light sources and a portion of the light guide inside a housing with a reflective inner surface and by having a wavelength conversion process occurring inside the light guide, this construction enables light from several light sources to be used for providing a single high-intensity and high-power light source.

WO2016/075014 A1 describes a lighting device comprising a plurality of solid state light sources and an elongated ceramic body having a first face and a second face defining a length (L) of the elongated ceramic body, the elongated ceramic body comprising one or more radiation input faces and a radiation exit window, wherein the second face comprises said radiation exit window, wherein the plurality of solid state light sources are configured to provide blue light source light to the one or more radiation input faces and are configured to provide to at least one of the radiation input faces a photon flux of at least 1.0*10¹⁷ photons/(s·mm²), wherein the elongated ceramic body comprises a ceramic material configured to wavelength convert at least part of the blue light source light into at least converter light, wherein the ceramic material comprises an A₃B₅O₁₂:Ce³⁺ ceramic material, wherein A comprises one or more of yttrium (Y), gadolinium (Gd) and lutetium (Lu), and wherein B comprises aluminum (Al).

WO2015/067476 describes a light emitting device comprising a plurality of first solid state light sources adapted for, in operation, emitting first light with a first spectral distribution, and a first light guide comprising a first light input surface, a first end surface extending in an angle different from zero with respect to each other and at least one first further surface extending parallel to the first light input surface, the plurality of first solid state light sources being arranged at the first light input surface. The first light guide is adapted for receiving the first light with the first spectral distribution at the first light input surface, and guiding at least a part of the first light with the first spectral distribution to the first end surface. The light emitting device further comprises at least one first optical element, which is adapted for shaping light that is coupled out of the first light guide through at least a part of the at least one first further surface such as to provide a first shaped light, and at least one second optical element arranged at or on the first end surface.

WO2011/004320 describes an illumination device comprising (a) a waveguide element comprising a first face, a second face, and a waveguide edge, and (b) a LED light source, arranged to generate light source light, with optional collimating optics. The LED light source with optional collimating optics is arranged to couple at least part of the light source light into the waveguide element via the waveguide edge of the waveguide element. The first face comprises structures arranged to couple at least part of the light out of the waveguide element via the second face to provide second face light. The illumination device further comprises a cavity, arranged to allow light to escape from the waveguide element into the cavity, and a reflector, arranged to reflect at least part of the light in the cavity in a direction away from the second face to provide first face light. Such an illumination device may allow lighting a room, for instance via the ceiling with uplight, and lighting a specific area in the room with downlight. Further, a relatively thin illumination device may be provided, which may for instance suspend from a ceiling.

US2012/206900 describes a light source module includes a light-emitting device emitting an excitation light beam, a reflective component including a reflective surface with a first focal point and a second focal point, a wavelength conversion device including a plurality of excited regions and disposed nearby the first focal point and on the transmission path of the excitation light beam, and an optical component. By rotating the wavelength conversion device, the excitation light beam irradiates the different excited regions at different time, so that the excitation light beam is converted into different wavelength light beams at different time, and the different wavelength light beams respectively correspond to the excited regions and are reflected by the reflective surface and converged at the second focal point. The optical component is disposed nearby the second focal point so the different wavelength light beams pass through the second focal point and are transmitted to the optical component.

EP2947484 A1 describes a light emitting device comprising at least one first light source adapted for, in operation, emitting first light with a first spectral distribution, at least one second light source adapted for, in operation, emitting second light with a second spectral distribution, a light guide comprising at least one first light input surface, at least one second light input surface and a first light exit surface, the at least one first light input surface and the first light exit surface extending at an angle different from zero with respect to each other, and a luminescent element arranged adjacent the first light exit surface, the light guide being adapted for converting at least a part of the first light with the first spectral distribution to third light with a third spectral distribution, guiding the second light and coupling at least a part of the third light and at least a part of the second light out of the first light exit surface, the luminescent element being adapted for converting at least a part of the second light to fourth light with a fourth spectral distribution.

### SUMMARY OF THE INVENTION

High brightness light sources are interesting for various applications including spots, stage-lighting, headlamps and digital light projection, etc. For this purpose, it is possible to make use of so-called light concentrators where shorter wavelength light is converted to longer wavelengths in a highly transparent luminescent material. A rod of such a transparent luminescent material can be illuminated by LEDs to produce longer wavelengths within the rod. Converted light which will stay in the luminescent material, such as a (trivalent cerium) doped garnet, in the waveguide mode and can then be extracted from one of the surfaces leading to an intensity gain.

One of the problems of this concept is related to the intensity of the LEDs used for pumping the luminescent waveguide. For this purpose, longer waveguides with more LEDs can be used. However, this may make the rod relatively long and more difficult to produce and more costly. This makes scalability for obtaining higher intensities relatively difficult.

Hence, it is an aspect of the invention to provide an alternative lighting device, which preferably further at least partly obviates one or more of above-described drawbacks, and which may have a relatively good efficiency and a high intensity, and which may efficiently guide away heat. The present invention may have as object to overcome or ameliorate at least one of the disadvantages of the prior art, or to provide a useful alternative. In this invention a new method for pumping of a luminescent concentrator rod is proposed by using the combination of (i) elliptical mirrors and optionally (ii) pre-collimation and/or pre-tilting of the discrete LED-sources. Especially, the invention may include using e.g. an elongated elliptical mirror and placing a light source (i.e. the LED) into one focal line of an ellipse, whereby the light will be redirected towards the second focal line (i.e. the luminescent rod). The light sources are hereby configured remote from the luminescent concentrator (such as a luminescent rod).

Hence, in a first aspect the invention provides a lighting device (“device”) comprising (a) a luminescent concentrator (“concentrator”), especially comprising an elongated light transmissive body (“body” or “elongated body” or “light transmissive body”) having a first face and a second face defining a length (L) of the light transmissive body, the light transmissive body comprising one or more radiation input faces (“input face” or “light incoupling face”) and a radiation exit window (“exit window”), wherein the second face may comprise said radiation exit window; the elongated light transmissive body especially comprising a luminescent material configured to convert at least part of light source light received at one or more radiation input faces into luminescent material light, and the luminescent concentrator configured to couple at least part of the luminescent material light out at the radiation exit window as converter light, (b) a light source mirror unit (“mirror unit” or “unit”), with the light source mirror unit comprising (b2) a plurality of light sources configured to provide said light source light in a direction of a curved mirror, and (b1) said curved mirror, configured to collect at least part of said light source light and configured to redirect the collected light source light to at least one of the one or more the radiation input faces of the luminescent concentrator. Especially, the lighting devices comprises a plurality of (such) light source units, such as 2-8 light source mirror units, wherein the light transmissive body further comprises one or more side faces, especially a plurality of side faces (such as at least two side faces, like e.g. four side faces) wherein two or more mirror units (of said plurality of (such) light source units, such as 2-8 light source mirror units) are configured to provide the light source light of the respective light sources to two or more different side faces.

In this way, the light sources are configured more remote from the luminescent concentrator, which allows using more light sources (as there is more space), and/or which allows a better coupling of cooling elements (such as heatsinks) with the luminescent concentrator. For instance, with the present invention more high-power LEDs at full output can be put around the luminescent concentrator, increasing the total pumping power and thereby the final brightness of the light source. Further, with the present solution e.g. more high-power LEDs at low/moderate output can be put around the luminescent concentrator, keeping the brightness at the same (or higher) level but with improved wall-plug efficiency (LEDs operated at low/moderate output power are more efficient). Yet further, it is e.g. possible to put more low-/mid-power LEDs at full output around the luminescent concentrator, keeping the brightness at the same (or higher) level but with a lower bill of material (cost of low-power versus high-power LEDs) as well as improved wall-plug efficiency if compared to high power LEDs. The invention also e.g. allows that the final light source has a more modular architecture, spatially decoupling the optical pumping module from the luminescent concentrator, facilitating assembly, alignment and (customer) component replacement, etc. In embodiments, by positioning the LED modules at a relatively large distance from the luminescent concentrator, the heat transfer process may be better defined by physically decoupling the cooling of the luminescent concentrator and cooling of the LED-modules. Each LED-module and the luminescent concentrator might have its own cooling means, ultimately leading to a more efficient cooling concept. Hence, the heat generated in the concentrator is not impacted by the even larger heat generated in the (blue) LED boards, and the LED board(s) illuminating the concentrator form one side are thermally fully decoupled from the LED board(s) illuminating the concentrator from the opposite side. Further, the invention also provides embodiments wherein the luminescent concentrator may be illuminated from all four long side faces (assuming a light transmissive body having a square or rectangular cross-section), while cooling/clamping (optionally with cooling elements) the concentrator from regions where the concentrator is not (much) illuminated. It also appears possible that the remote pumping may allow a more directional pumping input incident on the concentrator, giving rise to a lower reflectance levels in the absence of an anti-reflection coating on the concentrator.

Yet another benefit of the remote configuration relates to safety and electrical shielding aspects of the construction. In a confined configuration with the LED modules placed in proximity to the luminescent concentrator as well as the cooling means of the luminescent concentrator special care may have to be taken to allow safe operation and to shield high voltages residing on the LED modules from metal cooling parts. Obviously a potential electrical contacting between the electrical circuiting of the LED module and metal cooling parts of the rod could lead to unsafe situations and/or damage to the device. Extra space tolerancing and shielding and assembly precautions may be needed which add cost. Such measures are not needed in the remote configuration where the electrical LED module parts and metal luminescent concentrator cooling parts are spaced widely apart facilitating approbation of the device.

Yet another benefit is the opened-up construction around the luminescent concentrator that allows for an alternative or additional cooling means. For instance, the opened up space is typically filled up with air. This opens up an opportunity to allow an inlet of air flow into the construction typically from one inlet side towards and opposite outlet side with an airflow flowing substantially parallel; to the luminescent concentrator. Thus heat generated by the luminescent concentrator can be effectively removed by the air flow. The air flow may originate from a fan and be directed towards the light engine via a tunnel as well a removed from the outlet via tunnel. The luminescent concentrator may as such be only supported at a few positions to be mainly hanging in free space.

In addition or as alternative the opened-up space may be partly filled with a transparent heat-conducting envelope around the luminescent concentrator, for instance consisting of a transparent ceramic material. The envelope may be similarly shaped as the luminescent concentrator but preferably slightly larger, i.e. form a thin gap, such as to allow suitable heat transfer yet not frustrating total internal reflection within the concentrator. The luminescent concentrator may be hold in place inside the envelope by localized touch points that are not substantially in optical contact.

As indicated above, the device comprises a luminescent concentrator, which will further also be elucidated in more detail, and a light source mirror unit. The mirror unit comprises a light source, especially a plurality of light sources, configured to provide said light source light in a direction of a curved mirror, and (b1) said curved mirror is especially configured to collect at least part of said light source light and configured to redirect the collected light source light to at least one of the one or more the radiation input faces of the luminescent concentrator. The curved mirror is especially curved in one direction. Hence, the curved mirror may (also) be elongated having a curvature in a plane perpendicular to an axis of elongation.

The curved mirror may have substantially the same length as the light transmissive body. Hence, in embodiments the (elongated) curved mirror has a mirror length (L1) in the range of about 80-120% of the length (L) of the elongated light transmissive body wherein the curved mirror is especially configured parallel to the elongated light transmissive body.

In specific embodiments, especially curved mirrors may be applied that have an elliptical shape, or which curvature substantially follow the curvature of a curved part of an elliptical shape. Therefore, in specific embodiments the curved mirror may have an elliptical shape. Especially, the curved mirror, even more especially the curved mirror having an elliptical shape, may have a first focus and a second focus. The light sources may be configured at the first focus and the second focus may coincide with the light transmissive body. Especially, in embodiments the light sources have (flat) light emitting surfaces (such as LED dies), wherein one or more light emitting surfaces are configured at the first focus and wherein the elongated light transmissive body is configured at the second focus. Here, the term “focus” may refer to a focal point, but may especially refer to a focal line or a focal plane or a focal volume, as especially elongated curved mirrors are applied. In case the cross-section over the length of the mirror substantially has an elliptical shape (or thus substantially has the shape of a segment of an ellipse) the focus may be a line; deviations from elliptical may lead to focal planes or focal volumes. The focal line may have a length substantially identical to the length of the mirror. Likewise, this may apply to the length of a focal plane or a focal volume. The width of such focal plane or the equivalent diameter of such focal volume is especially in the range of the equivalent diameter (of the cross section) of the light transmissive body, such as in the range of about 150-20%, like in the range of about 100-20%. This may apply to both first and second focus (of the elliptical shaped mirror). The segment of the ellipse may especially be a half ellipse (including two focal points). Here, the half ellipse refers to the half that would e.g. be obtained when a full ellipse would be halved along the main or major axis. Hence, the curved mirrors may especially comprise half-elliptical mirrors.

Therefore, in embodiments the light source(s) may be configured at the first focal line (or a focal plane or a focal volume) and the second focal line (or a focal plane or a focal volume) may (at least partly) coincide with the light transmissive body. Hence, in embodiments the light emitting surfaces may be arranged such that they are close to (such as within about 5 mm), or substantially coincide with the first focus (focal line or a focal plane or a focal volume) and the focal line. Likewise, the radiation input faces may be arranged such that they are close to (such as within about 5 mm), or substantially coincide with the second focus (focal line or a focal plane or a focal volume) and the focal line. Optionally, the second focus may be further away from the radiation input face but then the second focus is especially within the light transmissive body. Herein, the term “focal line” may refer to “focal line”, but in embodiments also refer to focal plane or focal volume.

The term “curved mirror” may also refer to a plurality of curved mirrors. For instance, the light source mirror unit may include a plurality of curved mirrors, such as configured one next to the other to form an elongated mirror.

With the present invention, more free area at the light transmissive body may be provided for transfer of heat to another element or body, such as a heatsink. Thermal management may be important; hence a more efficient heat transfer away from the body may be desirable. In specific embodiments, the device further comprises a cooling element in thermal contact with the luminescent concentrator. Thermal contact may refer to physical contact or to non-physical contact but transfer of heat each via convection. Especially, thermal contact refers to physical contact, thereby allowing thermal conduction. For instance, the light transmissive body may be clamped between metal elements or clamps which may be further configured as heatsinks or which may be in thermal contact with heatsinks. In embodiments, the cooling element may include a heatsink (see also below).

Hence, with the present invention illuminated parts of the light transmissive body can better be separated from parts that are used for thermal contact with heatsinks as not all surface(s) of the light transmissive body that can be irradiated needs to be irradiated. With the light source mirror unit it is possible to couple more light into the light transmissive body with equal or less area than with conventional light concentrator devices. Hence, in specific embodiments the elongated light transmissive body comprises one or more side faces, wherein the one or more side faces comprise one or more radiation input faces, wherein the light source unit is configured to provide said light source light to a first part of the one or more side faces, the lighting device further comprising a cooling element in thermal contact with the luminescent concentrator, wherein the cooling element is in thermal contact with a second part of the one or more side faces. The cooling element can be a heatsink or an actively cooled element, such as a Peltier element. Further, the cooling element can be in thermal contact with the light transmissive body via other means, including heat transfer via air or with an intermediate element that can transfer heat, such as a thermal grease. Especially, however, the cooling element is in physical contact with the light transmissive body. The term “cooling element” may also refer to a plurality of (different) cooling elements.

Hence, the lighting device may include a heatsink configured to facilitate cooling of the solid state light source and/or luminescent concentrator. The heatsink may comprise or consist of copper, aluminum, silver, gold, silicon carbide, aluminum nitride, boron nitride, aluminum silicon carbide, beryllium oxide, silicon-silicon carbide, aluminum silicon carbide, copper tungsten alloys, copper molybdenum carbides, carbon, diamond, graphite, and combinations of two or more thereof. Hence, the term “heatsink” may also refer to a plurality of (different) heatsink. The lighting device may further include one or more cooling elements configured to cool the light transmissive body. With the present invention, cooling elements or heatsinks may be used to cool the light transmissive body and the same or different cooling elements or heatsinks may be used to cool the light sources. Optionally, the same or different cooling elements may also be used to cool the curved mirrors. The cooling elements or heatsinks may also provide interfaces to further cooling means or allow cooling transport to dissipate the heat to the ambient. For instance, the cooling elements or heatsinks may be connected to heat pipes or a water cooling systems that are connect to more remotely placed heatsinks or may be directly cooled by air flows such as generated by fans. Both passive and active cooling may be applied.

As indicated above, the lighting device comprises a plurality of light sources. These plurality of light sources may be configured to provide light source light to a single side or face or to a plurality of faces; see further also below. When providing light to a plurality of faces, in general each face will receive light of a plurality of light sources (a subset of the plurality of light sources). Hence, in embodiments a plurality of light sources will be configured to provide light source light (via the curved mirror) to a radiation input face. Also this plurality of light sources will in general be configured in a row. Hence, the light transmissive body is elongated, the light source mirror unit, or more especially the curved mirror may be elongated, and the plurality of light sources may be configured in a row, which may be substantially parallel to the axis of elongated of the curved mirror and/or the axis of elongated of the light transmissive body. The row of light sources may have substantially the same length as the elongated mirror and/or the elongated light transmissive body. Hence, in embodiments the (elongated) curved mirror has a mirror length (L1) in the range of about 80-120% of the second length (L2) of the row of light sources; or the row of light sources has a length in the range of about 80-120% of the length of the (elongated) curved mirror. Likewise, in embodiments the light transmissive body has a length (L) in the range of about 80-120% of the second length (L2) of the row of light sources; or the row of light sources has a length in the range of about 80-120% of the length of the light transmissive body.

Now, at the edges of the row the light source light may be coupled less efficient into the light transmissive body. For instance, as a solid state light source may show substantially a Lambertian distribution of the light source light, light may also be provided in a direction which may not allow efficient coupling of the light source light into the light transmissive body. Therefore, in embodiments the light sources are configured to provide light source light having an optical axis (O), wherein the elongated light transmissive body has a body axis (BA), wherein one or more light sources are configured to provide said light source light with said optical axis (O) perpendicular to the body axis (BA) and wherein one or more light sources are configured to provide said light source light with said optical axis (O) having an angle (β) smaller than 90° and equal to or larger than 35°, such as equal to or larger than 45°. The light transmissive body may have a central point (CP), especially on said body axis (BA). The light sources that are tilted will be tilted in the direction of such central point. Note that some tilt in the direction of the central point may be beneficial; it may not be necessary that the optical axis of the light source light of such light source and the central point substantially coincide at the central point.

In embodiments, the optical axes of the light sources are not directed to the light transmissive body but to curved the mirror. Hence, the light source(s) may be configured to provide the light source light in a direction of the curved mirror. Especially, in embodiments herein, at least part of the light source light, such as at least 50%, like at least 80%, such as at least 90%, such as in embodiments (essentially) all light source light is received by the curved mirror, and part thereof, after at least one reflection at the curved mirror may reach the light transmissive body. Hence, in embodiments at least 50%, like at least 80%, such as at least 90%, such as in embodiments (essentially) all light source light that is received by the light transmissive body is only received after a reflection at the curved mirror. Hence, for an essential part of the light source light received at the light transmissive body, the curved mirror may in fact be configured upstream of the light transmissive body and the one or more light source(s) may be configured upstream of the curved mirror. Hence, in embodiments the optical axes of the one or more light sources may not be directed to the light transmissive body (but to the curved mirror). In embodiments, the phrase “configured to provide light source light in a direction of a curved mirror” may especially indicate that the optical axis of the light source is directed to such curved mirror (and not to the light transmissive body). The optical axis may be defined is an imaginary line that defines the path along which light propagates through the system, which may initically thus have a direct path from the light source to the curved mirror, and an indirect path (i.e. including at least a reflection at the curved mirror) to the light transmissive body.

Hence, in embodiments the curved mirror may thus be configured as collector or beam shaping element, configured to collect at least part of the light source light and redirect that light (after reflection) to the light transmissive body.

The efficiency of the lighting device may further be improved by precollimating the light source light of the light sources. With the more remote location of the light sources, also space is created for (small) collimators. An advantage of precollimation is that the angles with which the light source, after being reflected by the curved mirrors, reach the surface may be smaller. This may lead to less light loss due to reflection at the radiation input face. As indicated above, and as will be further discussed below, the light source may especially be solid state light source. Such light sources may have substantially flat light emitting surfaces, often indicated as dies. Hence, in specific embodiments the light sources comprise solid state light sources having (substantially flat) light emitting surfaces with downstream thereof collimators for a pre-collimation of the light source light. Examples of collimators may be, lenses, such as glass or plastic lenses, TIR collimators, or curved mirrors, like compound parabolic collimators (CPCs). Assuming solid state light sources, the precollimation may especially be done with a pre-collimating element configured to precollimate the light source light of a few, or only one light source.

Another means to increase the efficiency is the use of domes on the solid state light sources (especially on the dies), such as silicone domes. The dome, typically of half-sphere shape may be larger than the emitter dies, for instance 2 to 3 times as large. The dome especially serves the purpose of extraction optics to increase the light output efficiency of the die, by for instance 20-30%. In the non-remote configuration there is no space for such extraction optics. Hence the efficiency of the light sources may be increased or less light sources components can be used.

In specific embodiments, the elongated light transmissive body is at least partly enclosed by a light transmissive envelope (which light transmissive envelope is especially not used for light conversion). Such embodiments may especially be combined with embodiments wherein the lighting device further comprises a cooling element in thermal contact with part of the light transmissive envelope. As there is now more space (due to the larger cross-section) a light transmissive shell may be used to cool the light transmissive body whereas the light source light may substantially completely be transmitted through the light transmissive envelope. In embodiments, the light transmissive body comprises a ceramic material comprising a luminescent material and the light transmissive envelope comprises the same ceramic material, but not substantially comprising the luminescent material (or another luminescent material), e.g. not to be doped. Some examples include YAG, LuAG, LuYAG, Y₂O₃, Al₂O₃, spinel. For instance, a possibility for the ceramic material of the light transmissive envelope is transparent (densily sintered) alumina. For instance, the ceramic envelop may be pressed around the light transmissive body (which comprises the luminescent material), preferably, however, in a way that optical contact between the transmissive elongated body and the tranmissive envelope is avoided. Hence, the light transmissive body may be configured in thermal contact with the light transmissive envelope (or, in other words the light transmissive envelope may be in thermal contact with the light transmissive body).

Therefore, in yet a further aspect the invention also provides a lighting device comprising a luminescent concentrator comprising an elongated light transmissive body (having a first face and a second face defining a length (L) of the light transmissive body, the light transmissive body comprising one or more radiation input faces and a radiation exit window, wherein the second face comprises said radiation exit window; the elongated light transmissive body comprising a luminescent material configured to convert at least part of light source light received at one or more radiation input faces into luminescent material light, and the luminescent concentrator configured to couple at least part of the luminescent material light out at the radiation exit window as converter light), wherein the elongated light transmissive body is at least partly enclosed by a light transmissive envelope.

Especially, this light transmissive envelope encloses the edge(s) of the light transmissive body (and not the first face and/or second face). Of course, such lighting device may (also) further include the light source mirror unit as further defined herein. There may substantially be no optical contact between the light transmissive body and the light transmissive envelope.

For further improving efficiency and/or for improving the spectral distribution several optical elements may be included like mirrors, optical filters, optics, etc. In specific embodiments, the lighting device may have a mirror configured at the first face configured to reflect light back into the elongated light transmissive body, and/or may have one or more of an optical filter, a (wavelength selective) mirror, light extraction structures, and a collimator configured at the second face. At the second face the mirror may e.g. a wavelength selective mirror or a mirror including a hole. In the latter embodiment, light may be reflected back into the body but part of the light may escape via the hole. Especially, in embodiments the optical element may be configured at a distance of about 0.1-1 mm from the body.

The term “light source mirror unit” may in embodiments also refer to a plurality of such units. These units may be configured in a row, substantially parallel to a single radiation input face. However, two or more units may also be configured to provide light source light to different radiation input faces. Therefore, in embodiments the lighting device may e.g. comprise 2-8 light source mirror units. Here, the number 2-8 especially refers to the number of units that can be configured circumferentially surrounding the light transmissive body over at least part of its length. By way of example, assuming all mirror units having a length substantially the same as the length of the elongated light transmissive body, 1-8, such as 2-8 mirror element may be configured around the elongated light transmissive body. More than 8 mirror elements may reduce efficiency. Especially, 2-4 mirror elements may be applied. Here, again it is meant that in a cross-sectional plane, with the plane being perpendicular to the body axis, 2-4 mirror elements may be configured around the elongated light transmissive body. Hence, in specific embodiments the elongated light transmissive body comprises one or more side faces, wherein two or more mirror units are configured to provide the light source light of the respective light sources to two or more different side faces.

When more than one mirror element is used to address more than one side face, there may still be (enough) space to thermally contact the elongated light transmissive body with cooling elements or heatsinks. Hence, in embodiments the elongated light transmissive body comprises one or more side faces, wherein the one or more side faces comprise one or more radiation input faces, wherein two or more mirror units are configured to provide said light source light to one or more firsts part of the one or more side faces, the lighting device further comprising a cooling element in thermal contact with the luminescent concentrator, especially wherein the cooling element, such as a heatsink, is in physical contact with one or more second parts of the one or more side faces, though a small air gap (e.g. 0.1-1 mm, like 0.1-0.5 mm) may also be configured between the concentrator and the cooling element.

In yet a further aspect, the invention also provides the light source mirror unit per se, which may especially comprise a plurality of light sources configured to provide said light source light in a direction of a curved mirror, wherein the light sources are especially configured in a row having a row length, wherein especially the plurality of light sources are configured at a first focus, especially a first focal line, of said curved mirror; wherein said curved mirror, configured to collect at least part of said light source light and configured to redirect in the direction of a second focus, especially a second focal line (or optionally focal plane or focal volume), wherein the curved mirror has a mirror length, wherein the mirror length and the row length are substantially the same. Especially, the (elongated) curved mirror has a mirror length in the range of 80-120% of the length of row of light sources.

The lighting device may be configured to provide blue, green, yellow, orange, or red light, etc. Further, in specific embodiment, the lighting device may be configured to provide white light. If desired, monochromaticity may be improved with the above indicated optical filter(s).

The term “light concentrator” is herein used, as a plurality of light sources irradiate a relative large surface (area) of the light converter, and a lot of converter light may escape from a relatively small area (exit window) of the light converter. Thereby, the specific configuration of the light converter provides its light concentrator properties. Especially, the light concentrator may provide Stokes-shifted light, which is Stokes shifted relative to the pump radiation.

The terms “upstream” and “downstream” relate to an arrangement of items or features relative to the propagation of the light from a light generating means (here the especially the light source(s)), wherein relative to a first position within a beam of light from the light generating means, a second position in the beam of light closer to the light generating means is “upstream”, and a third position within the beam of light further away from the light generating means is “downstream”.

The light concentrator comprises a light transmissive body. The light concentrator is especially described in relation to an elongated light transmissive body, such as a ceramic rod or a crystal, such as a single crystal. However, these aspects may also be relevant for other shaped ceramic bodies or single crystals.

The light transmissive body has light guiding or wave guiding properties. Hence, the light transmissive body is herein also indicated as waveguide or light guide. As the light transmissive body is used as light concentrator, the light transmissive body is herein also indicated as light concentrator. The light transmissive body will in general have (some) transmission of visible light in a direction perpendicular to the length of the light transmissive body. Without the activator (dopant) such as trivalent cerium, the transmission in the visible might be close to 100%.

Herein, the term “visible light” especially relates to light having a wavelength selected from the range of 380-780 nm. The transmission can be determined by providing light at a specific wavelength with a first intensity to the light transmissive body under perpendicular radiation and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

The light transmissive body may have any shape, such as beam like or rod like, however especially beam like (cuboid like). However, the light transmissive body may also be disk like, etc. The invention is not limited to specific embodiments of shapes, neither is the invention limited to embodiments with a single exit window or outcoupling face. Below, some specific embodiments are described in more detail. Would the light transmissive body have a circular cross-section, then the width and height may be equal (and may be defined as diameter). Especially, however, the light transmissive body has a cuboid like shape and is further configured to provide a single exit window.

In a specific embodiment, the light transmissive body may especially have an aspect ratio larger than 1, i.e. the length is larger than the width. In general, the light transmissive body is a rod or bar (beam), though the light transmissive body does not necessarily have a square, rectangular or round cross-section. In general, the light source is configured to irradiate one of the longer faces (side edge), herein indicated as radiation input face, and radiation escapes from a face at a front (front edge), herein indicated as radiation exit window. Especially, in embodiments the solid state light source, or other light source, is not in physical contact with the light transmissive body. Physical contact may lead to undesired outcoupling and thus a reduction in concentrator efficiency. Further, in general the light transmissive body comprises two substantially parallel faces, the radiation input face and opposite thereof the opposite face. These two faces define herein the width of the light transmissive body. In general, the length of these faces defines the length of the light transmissive body. However, as indicated above, and also below, the light transmissive body may have any shape, and may also include combinations of shapes. Especially, the radiation input face has an radiation input face area (A), wherein the radiation exit window has a radiation exit window area (E), and wherein the radiation input face area (A) is at least 1.5 times, even more especially at least two times larger than the radiation exit window area (E), especially at least 5 times larger, such as in the range of 2-50,000, especially 5-5,000 times larger. Hence, especially the elongated light transmissive body comprises a geometrical concentration factor, defined as the ratio of the area of the radiation input faces and the area of the radiation exit window, of at least 1.5, such as at least 2, like at least 5, or much larger (see above). This allows e.g. the use of a plurality of solid state light sources (see also below). For typical applications like in automotive or digital projectors, a small but high intense emissive surface is desired. This cannot be obtained with a single LED, but can be obtained with the present lighting device. Especially, the radiation exit window has a radiation exit window area (E) selected from the range of 1-100 mm². With such dimensions, the emissive surface can be small, whereas nevertheless high intensity may be achieved. As indicated above, the light transmissive body in general has an aspect ratio (of length/width). This allows a small radiation exit surface, but a large radiation input surface, e.g. irradiated with a plurality of solid state light sources. In a specific embodiment, the light transmissive body has a width (W) selected from the range of 0.5-100 mm. The light transmissive body is thus especially an integral body, having the herein indicated faces.

The generally rod shaped or bar shaped light transmissive body can have any cross sectional shape, but in embodiments has a cross section the shape of a square, rectangle, round, oval, triangle, pentagon, or hexagon. Generally the ceramic or crystal bodies are cuboid, but may be provided with a different shape than a cuboid, with the light input surface having somewhat the shape of a trapezoid. By doing so, the light flux may be even enhanced, which may be advantageous for some applications. Hence, in some instances (see also above) the term “width” may also refer to diameter, such as in the case of a light transmissive body having a round cross section. Hence, in embodiments the elongated light transmissive body further has a width (W) and a height (H), with especially L>W and L>H. Especially, the first face and the second face define the length, i.e. the distance between these faces is the length of the elongated light transmissive body. These faces may especially be arranged parallel. Further, in a specific embodiment the length (L) is at least 2 cm, such as 10-20 cm.

Especially, the light transmissive body has a width (W) selected to absorb more than 95% of the light source light. In embodiments, the light transmissive body has a width (W) selected from the range of 0.05-4 cm, especially 0.1-2 cm, such as 0.2-1.5 cm. With the herein indicated cerium concentration, such width is enough to absorb substantially all light generated by the light sources.

The light transmissive body may also be a cylindrically shaped rod. In embodiments the cylindrically shaped rod has one flattened surface along the longitudinal direction of the rod and at which the light sources may be positioned for efficient incoupling of light emitted by the light sources into the light transmissive body. The flattened surface may also be used for placing heatsinks. The cylindrical light transmissive body may also have two flattened surfaces, for example located opposite to each other or positioned perpendicular to each other. In embodiments the flattened surface extends along a part of the longitudinal direction of the cylindrical rod. Especially however, the edges are planar and configured perpendicular to each other.

The light transmissive body may also be a fiber or a multitude of fibers, for instance a fiber bundle, either closely spaced or optically connected in a transparent material. The fiber may be referred to as a luminescent fiber. The individual fiber may be very thin in diameter, for instance, 0.1 to 0.5 mm.

The light transmissive body as set forth below in embodiments according to the invention may also be folded, bended and/or shaped in the length direction such that the light transmissive body is not a straight, linear bar or rod, but may comprise, for example, a rounded corner in the form of a 90 or 180 degrees bend, a U-shape, a circular or elliptical shape, a loop or a 3-dimensional spiral shape having multiple loops. This provides for a compact light transmissive body of which the total length, along which generally the light is guided, is relatively large, leading to a relatively high lumen output, but can at the same time be arranged into a relatively small space. For example luminescent parts of the light transmissive body may be rigid while transparent parts of the light transmissive body are flexible to provide for the shaping of the light transmissive body along its length direction. The light sources may be placed anywhere along the length of the folded, bended and/or shaped light transmissive body.

Parts of the light transmissive body that are not used as light incoupling area or light exit window may be provided with a reflector. Hence, in an embodiment the lighting device further comprises a reflector configured to reflect luminescent material light back into the light transmissive body. Therefore, the lighting device may further include one or more reflectors, especially configured to reflect radiation back into the light transmissive body that escapes from one or more other faces than the radiation exit window. Especially, a face opposite of the radiation exit window may include such reflector, though in an embodiment not in physical contact therewith. Hence, the reflectors may especially not be in physical contact with the light transmissive body. Therefore, in an embodiment the lighting device further comprises an optical reflector (at least) configured downstream of the first face and configured to reflect light back into the elongated light transmissive body. Alternatively or additionally, optical reflectors may also be arranged at other faces and/or parts of faces that are not used to couple light source light in or luminescence light out. Especially, such optical reflectors may not be in physical contact with the light transmissive body. Further, such optical reflector(s) may be configured to reflect one or more of the luminescence and light source light back into the light transmissive body. Hence, substantially all light source light may be reserved for conversion by the luminescent material (i.e. the activator element(s) such as especially Ce³⁺) and a substantial part of the luminescence may be reserved for outcoupling from the radiation exit window. The term “reflector” may also refer to a plurality of reflectors.

The terms “coupling in” and similar terms and “coupling out” and similar terms indicate that light changes from medium (external from the light transmissive body into the light transmissive body, and vice versa, respectively). In general, the light exit window will be a face (or a part of a face), configured (substantially) perpendicular to one or more other faces of the waveguide. In general, the light transmissive body will include one or more body axes (such as a length axis, a width axis or a height axis), with the exit window being configured (substantially) perpendicular to such axis. Hence, in general, the light input face(s) will be configured (substantially) perpendicular to the light exit window. Thus, the radiation exit window is especially configured perpendicular to the one or more radiation input faces. Therefore, especially the face comprising the light exit window does not comprise a light input face.

Downstream of the radiation exit window, optionally an optical filter may be arranged. Such optical filter may be used to remove undesired radiation. For instance, when the lighting device should provide red light, all light other than red may be removed. Hence, in a further embodiment the lighting device further comprises an optical filter configured downstream of the radiation exit window and configured to reduce the relative contribution of non-red light in the converter light (downstream of the radiation exit window). For filtering out light source light, optionally an interference filter may be applied. Likewise this may apply to another color, when a color other than green and red is desired.

In yet a further embodiment, the lighting device further comprises a collimator configured downstream of the radiation exit window (of the highest order luminescent concentrator) and configured to collimate the converter light. Such collimator, like e.g. a CPC (compound parabolic concentrator), may be used to collimate the light escaping from the radiation exit window and to provide a collimated beam of light.

Especially, the light sources are light sources that during operation emit (light source light) at least light at a wavelength selected from the range of 200-490 nm, especially light sources that during operation emit at least light at wavelength selected from the range of 400-490 nm, even more especially in the range of 440-490 nm. This light may partially be used by the luminescent material. Hence, in a specific embodiment, the light source is configured to generate blue light. In a specific embodiment, the light source comprises a solid state light source (such as a LED or laser diode). The term “light source” may also relate to a plurality of light sources, such as e.g. 2-1000, such as 2-200, like 2-50, especially 2-20 (solid state) LED light sources, though many more light sources may be applied. Hence, the term LED may also refer to a plurality of LEDs. Hence, as indicated herein, the term “solid state light source” may also refer to a plurality of solid state light sources. In an embodiment (see also below), these are substantially identical solid state light sources, i.e. providing substantially identical spectral distributions of the solid state light source radiation. In embodiments, the solid state light sources may be configured to irradiate different faces of the light transmissive body.

The lighting device comprises a plurality of light sources. Especially, the light source light of the plurality (m) of light sources have spectral overlap, even more especially, they are of the same type and provide substantial identical light (having thus substantial the same spectral distribution). Hence, the light sources may substantially have the same emission maximum (“peak maximum”), such as within a bandwidth of 10 nm, especially within 8 nm, such as within 5 nm (binning).

The light sources are especially configured to provide a blue optical power (Wₒₚₜ) of at least 0.2 Watt/mm² to the light transmissive body, i.e. to the radiation input face(s). The blue optical power is defined as the energy that is within the energy range that is defined as blue part of the spectrum (see also below). Especially, the photon flux is in average at least 4.5*10¹⁷ photons/(s·mm²), such as at least 6.0*10¹⁷ photons/(s·mm²). Assuming blue (excitation) light, this may e.g. correspond to a blue power (Wₒₚₜ) provided to at least one of the radiation input faces of in average at least 0.067 Watt/mm² and 0.2 Watt/mm², respectively. Here, the term “in average” especially indicates an average over the area (of the at least one of the radiation input surfaces). When more than one radiation input surface is irradiated, then especially each of these radiation input surfaces receives such photon flux. Further, especially the indicated photon flux (or blue power when blue light source light is applied) is also an average over time.

In yet a further embodiment, especially for projector applications, the plurality of light sources are operated in pulsed operation with a duty cycle selected from the range of 10-80%, such as 25-70%.

The lighting device may comprise a plurality of luminescent concentrators, such as in the range of 2-50, like 3-20 light concentrators (which may e.g. be stacked).

The light concentrator may radiationally be coupled with one or more light sources, especially a plurality of light sources, such as 2-1000, like 2-50 light sources. The term “radiationally coupled” especially means that the light source and the light concentrator are associated with each other so that at least part of the radiation emitted by the light source is received by the light concentrator (and at least partly converted into luminescence).

Hence, the luminescent concentrator receives at one or more radiation input faces radiation (pump radiation) from an upstream configured light concentrator or from upstream configured light sources. Further, the light concentrator comprises a luminescent material configured to convert at least part of a pump radiation received at one or more radiation input faces into luminescent material light, and the luminescent concentrator configured to couple at least part of the luminescent material light out at the radiation exit window as converter light. This converter light is especially used as component of the lighting device light.

The phrase “configured to provide luminescent material light at the radiation exit window” and similar phrases especially refers to embodiments wherein the luminescent material light is generated within the luminescent concentrator (i.e. within the light transmissive body), and part of the luminescent material light will reach the radiation exit window and escape from the luminescent concentrator. Hence, downstream of the radiation exit window the luminescent material light is provided. The converter light, downstream of the radiation exit window comprises at least the luminescent material light escaped via the radiation exit window from the light converter. Instead of the term “converter light” also the term “light concentrator light” may be used. Pump radiation can be applied to a single radiation input face or a plurality of radiation input faces.

In embodiments, the length (L) is selected from the range of 1-100 cm, such as especially 5-50 cm. This may thus apply to all luminescent concentrators. However, the range indicates that the different luminescent concentrators may have different lengths within this range.

In yet further embodiments, the elongated light transmissive body (of the luminescent concentrator) comprises an elongated ceramic body. For instance, luminescent ceramic garnets doped with Ce³⁺ (trivalent cerium) can be used to convert blue light into light with a longer wavelength, e.g. within the green to red wavelength region, such as in the range of about 500-750 nm. To obtain sufficient absorption and light output in desired directions, it is advantageous to use transparent rods (especially substantially shaped as beams). Such rod can be used as light concentrator, concentrating over their length light source light from light sources such as LEDs (light emitting diodes), converting this light source light into converter light and providing at an exit surface a substantial amount of converter light. Lighting devices based on light concentrators may e.g. be of interest for projector applications. For projectors, red and green luminescent concentrators are of interest. Green luminescent rods, based on garnets, can be relatively efficient. Such concentrators are especially based on YAG:Ce (i.e. Y₃Al₅O₁₂:Ce³⁺) or LuAG (Lu₃Al₅O₁₂:Ce³⁺). ‘Red’ garnets can be made by doping a YAG-garnet with Gd (“YGdAG”).

Hence, especially the elongated light transmissive body comprises a ceramic material configured to wavelength convert at least part of the (blue) light source light into converter light in the red, which converter light at least partly escapes from the radiation exit window. The ceramic material especially comprises an A₃B₅O₁₂:Ce³⁺ ceramic material (“ceramic garnet”), wherein A comprises yttrium (Y) and gadolinium (Gd), and wherein B comprises aluminum (Al). As further indicated below, A may also refer to other rare earth elements and B may include Al only, but may optionally also include gallium. The formula A₃B₅O₁₂:Ce³⁺ especially indicates the chemical formula, i.e. the stoichiometry of the different type of elements A, B and O (3:5:12). However, as known in the art the compounds indicated by such formula may optionally also include a small deviation from stoichiometry.

In yet a further aspect, the invention also provides such elongated light transmissive body per se, i.e. an elongated light transmissive body having a first face and a second face, these faces especially defining the length (L) of the elongated light transmissive body, the elongated light transmissive body comprising one or more radiation input faces and a radiation exit window, wherein the second face comprises said radiation exit window, wherein the elongated light transmissive body comprises a ceramic material configured to wavelength convert at least part of (blue) light source light into converter light, such as (at least) red converter light (which at least partly escapes from the radiation exit window when the elongated light transmissive body is irradiated with blue light source light), wherein the ceramic material comprises an A₃B₅O₁₂:Ce³⁺ ceramic material as defined herein. Such light transmissive body can thus be used as light converter. Especially, such light transmissive body has the shape of a cuboid.

As indicated above, the ceramic material comprises a garnet material. Hence, the elongated body especially comprises a luminescent ceramic. The garnet material, especially the ceramic garnet material, is herein also indicated as “luminescent material”. The luminescent material comprises an A₃B₅O₁₂:Ce³⁺ (garnet material), wherein A is especially selected from the group consisting of Sc, Y, Tb, Gd, and Lu (especially at least Y and Gd), wherein B is especially selected from the group consisting of Al and Ga (especially at least Al). More especially, A (essentially) comprises yttrium (Y) and gadolinium (Gd), and B (essentially) comprises aluminum (Al). Such garnet is be doped with cerium (Ce), and optionally with other luminescent species such as praseodymium (Pr).

As indicated above, the element A may especially be selected from the group consisting of yttrium (Y) and gadolinium (Gd). Hence, A₃B₅O₁₂:Ce³⁺ especially refers to (Y₁₋ₓGdₓ)₃B₅O₁₂:Ce³⁺, wherein especially x is in the range of 0.1-0.5, even more especially in the range of 0.2-0.4, yet even more especially 0.2-0.35. Hence, A may comprise in the range of 50-90 atom % Y, even more especially at least 60-80 atom % Y, yet even more especially 65-80 atom % of A comprises Y. Further, A comprises thus especially at least 10 atom % Gd, such as in the range of 10-50 atom % Gd, like 20-40 atom %, yet even more especially 20-35 atom % Gd.

Especially, B comprises aluminum (Al), however, B may also partly comprise gallium (Ga) and/or scandium (Sc) and/or indium (In), especially up to about 20% of Al, more especially up to about 10% of Al may be replaced (i.e. the A ions essentially consist of 90 or more mole % of Al and 10 or less mole % of one or more of Ga, Sc and In); B may especially comprise up to about 10% gallium. Therefore, B may comprise at least 90 atom % Al. Hence, A₃B₅O₁₂:Ce³⁺ especially refers to (Y₁₋ₓGdₓ)₃Al₅O₁₂:Ce³⁺, wherein especially x is in the range of 0.1-0.5, even more especially in the range of 0.2-0.4.

In another variant, B (especially Al) and O may at least partly be replaced by Si and N. Optionally, up to about 20% of Al—O may be replaced by Si-N, such as up to 10%.

For the concentration of cerium, the indication n mole % Ce indicates that n % of A is replaced by cerium. Hence, A₃B₅O₁₂:Ce³⁺ may also be defined as (A₁₋ₙCeₙ)₃B₅O₁₂, with n being in the range of 0.001-0.035, such as 0.0015-0.01. Therefore, a garnet essentially comprising Y and mole Ce may in fact refer to ((Y₁₋ₓGdₓ)₁₋ₙCeₙ)₃B₅O₁₂, with x and n as defined above.

Especially, the ceramic material is obtainable by a sintering process and/or a hot pressing process, optionally followed by an annealing in an (slightly) oxidizing atmosphere. The term “ceramic” especially relates to an inorganic material that is—amongst others—obtainable by heating a (poly crystalline) powder at a temperature of at least 500° C., especially at least 800° C., such as at least 1000° C., like at least 1400° C., under reduced pressure, atmospheric pressure or high pressure, such as in the range of 10⁻⁸ to 500 MPa, such as especially at least 0.5 MPa, like especially at least 1 MPa, like 1 to about 500 MPa, such as at least 5 MPa, or at least 10 MPa, especially under uniaxial or isostatic pressure, especially under isostatic pressure. A specific method to obtain a ceramic is hot isostatic pressing (HIP), whereas the HIP process may be a post-sinter HIP, capsule HIP or combined sinter-HIP process, like under the temperature and pressure conditions as indicate above. The ceramic obtainable by such method may be used as such, or may be further processed (like polishing). A ceramic especially has density that is at least 90% (or higher, see below), such as at least 95%, like in the range of 97-100%, of the theoretical density (i.e. the density of a single crystal). A ceramic may still be polycrystalline, but with a reduced, or strongly reduced volume between grains (pressed particles or pressed agglomerate particles). The heating under elevated pressure, such as HIP, may e.g. be performed in an inert gas, such as comprising one or more of N₂ and argon (Ar). Especially, the heating under elevated pressures is preceded by a sintering process at a temperature selected from the range of 1400-1900° C., such as 1500-1800° C. Such sintering may be performed under reduced pressure, such as at a pressure of 10⁻² Pa or lower. Such sintering may already lead to a density of in the order of at least 95%, even more especially at least 99%, of the theoretical density. After both the pre-sintering and the heating, especially under elevated pressure, such as HIP, the density of the light transmissive body can be close to the density of a single crystal. However, a difference is that grain boundaries are available in the light transmissive body, as the light transmissive body is polycrystalline. Such grain boundaries can e.g. be detected by optical microscopy or SEM. Hence, herein the light transmissive body especially refers to a sintered polycrystalline having a density substantially identical to a single crystal (of the same material). Such body may thus be highly transparent for visible light (except for the absorption by the light absorbing species such as especially Ce³⁺).

The luminescent concentrator may also be a crystal, such as a single crystal. Such crystals can be grown/drawn from the melt in a higher temperature process. The large crystal, typically referred to as boule, can be cut into pieces to form the light transmissive bodies. The polycrystalline garnets mentioned above are examples of materials that can alternatively also be grown in single crystalline form.

After obtaining the light transmissive body, the body may be polished. Before or after polishing an annealing process (in an oxidative atmosphere) may be executed, especially before polishing. In a further specific embodiment, said annealing process lasts for at least 2 hours, such as at least 2 hours at at least 1200° C. Further, especially the oxidizing atmosphere comprises for example O₂.

Instead of cerium doped garnets, or in addition to such garnets, also other luminescent materials may be applied, e.g. embedded in organic or inorganic light transmissive matrixes, as luminescent concentrator. For instance quantum dots and/or organic dyes may be applied and may be embedded in transmissive matrices like e.g. polymers, like PMMA, or polysiloxanes, etc. etc. . . . .

Quantum dots are small crystals of semiconducting material generally having a width or diameter of only a few nanometers. When excited by incident light, a quantum dot emits light of a color determined by the size and material of the crystal. Light of a particular color can therefore be produced by adapting the size of the dots. Most known quantum dots with emission in the visible range are based on cadmium selenide (CdSe) with a shell such as cadmium sulfide (CdS) and zinc sulfide (ZnS). Cadmium free quantum dots such as indium phosphode (InP), and copper indium sulfide (CuInS₂) and/or silver indium sulfide (AgInS₂) can also be used. Quantum dots show very narrow emission band and thus they show saturated colors. Furthermore the emission color can easily be tuned by adapting the size of the quantum dots. Any type of quantum dot known in the art may be used in the present invention. However, it may be preferred for reasons of environmental safety and concern to use cadmium-free quantum dots or at least quantum dots having a very low cadmium content.

Organic phosphors can be used as well. Examples of suitable organic phosphor materials are organic luminescent materials based on perylene derivatives, for example compounds sold under the name Lumogen® by BASF. Examples of suitable compounds include, but are not limited to, Lumogen® Red F305, Lumogen® Orange F240, Lumogen® Yellow F083, and Lumogen® F170.

Several color conversion schemes may be possible. Especially, however, the Stokes shift is relatively small. Especially, the Stokes shift, defined as the difference (in wavelength) between positions of the band maxima of the light source used for pumping and the light which is emitted, is not larger than 100 nm; especially however, the Stokes shift is at least about 10 nm, such as at least about 20 nm. This may especially apply to the light source light to first luminescent material light conversion, but also apply to the second pump radiation to second luminescent material light conversion, etc.

In embodiments, the plurality of light sources are configured to provide UV radiation as first pump radiation, and the luminescent concentrators are configured to provide one or more of blue and green first converter light. In yet other embodiments, the plurality of light sources are configured to provide blue radiation as first pump radiation, and the luminescent concentrators are configured to provide one or more of green and yellow first converter light. Note, as also indicated below, such embodiments may also be combined.

In embodiments, the light concentrator may comprise a rectangular bar (rod) of a phosphor doped, high refractive index garnet, capable to convert e.g. blue light into green, yellow and/or red light and to collect this green, yellow and/or red light in a small étendue output beam. The rectangular bar may have six surfaces, four large surfaces over the length of the bar forming the four side walls, and two smaller surfaces at the end of the bar, with one of these smaller surfaces forming the “nose” where the desired light is extracted.

The light concentrator comprises a light transmissive body. The light concentrator is especially described in relation to an elongated light transmissive body, such as a ceramic rod or a crystal, such as a single crystal. However, these aspects may also be relevant for other shaped ceramic bodies or single crystals. Hence, in embodiments the elongated light transmissive body may e.g. comprise a ceramic body and in other embodiments the elongated light transmissive body may e.g. comprise a single crystal.

The lighting device may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, green house lighting systems, horticulture lighting, or LCD backlighting, etc.

In yet a further aspect, the invention provides a projector comprising the lighting device as defined herein. As indicated above, of course the light projector may also include a plurality of such lighting devices.

In yet a further aspect, the invention also provides a lighting system configured to provide lighting system light, the lighting system comprising one or more lighting devices as defined herein. Here, the term “lighting system” may also be used for a (digital) projector. Further, the lighting device may be used for e.g. stage lighting (see further also below). Therefore, in embodiments the invention also provides a lighting system as defined herein, wherein the lighting system comprises a digital projector or a stage lighting system. The lighting system may comprise one or more lighting devices as defined herein and optionally one or more second lighting devices configured to provide second lighting device light, wherein the lighting system light comprises (a) one or more of (i) said converter light as defined herein, and optionally (b) second lighting device light. Hence, the invention also provides a lighting system configured to provide visible light, wherein the lighting system comprises at least one lighting device as defined herein. For instance, such lighting system may also comprise one or more (additional) optical elements, like one or more of optical filters, collimators, reflectors, wavelength converters, etc. The lighting system may be, for example, a lighting system for use in an automotive application, like a headlight. Hence, the invention also provides an automotive lighting system configured to provide visible light, wherein the automotive lighting system comprises at least one lighting device as defined herein and/or a digital projector system comprising at least one lighting device as defined herein. Especially, the lighting device may be configured (in such applications) to provide red light. The automotive lighting system or digital projector system may also comprise a plurality of the lighting devices as described herein.

The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL.

The terms “violet light” or “violet emission” especially relates to light having a wavelength in the range of about 380-440 nm. The terms “blue light” or “blue emission” especially relates to light having a wavelength in the range of about 440-490 nm (including some violet and cyan hues). The terms “green light” or “green emission” especially relate to light having a wavelength in the range of about 490-560 nm. The terms “yellow light” or “yellow emission” especially relate to light having a wavelength in the range of about 560-570 nm. The terms “orange light” or “orange emission” especially relate to light having a wavelength in the range of about 570-600. The terms “red light” or “red emission” especially relate to light having a wavelength in the range of about 600-780 nm. The term “pink light” or “pink emission” refers to light having a blue and a red component. The terms “visible”, “visible light” or “visible emission” refer to light having a wavelength in the range of about 380-780 nm.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1e schematically depict some aspects of the invention;

FIGS. 2a-2d schematically depict some aspects;

FIGS. 3a-3c schematically depict some embodiments;

FIGS. 4a-4b schematically depict some aspects;

FIGS. 5a-5b schematically depict some further variants; and

FIGS. 6a-6b schematically depict some embodiments.

The schematic drawings are not necessarily on scale.

### DETAILED DESCRIPTION OF THE EMBODIMENTS

A light emitting device according to the invention may be used in applications including but not being limited to a lamp, a light module, a luminaire, a spot light, a flash light, a projector, a (digital) projection device, automotive lighting such as e.g. a headlight or a taillight of a motor vehicle, arena lighting, theater lighting and architectural lighting.

Light sources which are part of the embodiments according to the invention as set forth below, may be adapted for, in operation, emitting light with a first spectral distribution. This light is subsequently coupled into a light guide or waveguide; here the light transmissive body. The light guide or waveguide may convert the light of the first spectral distribution to another spectral distribution and guides the light to an exit surface.

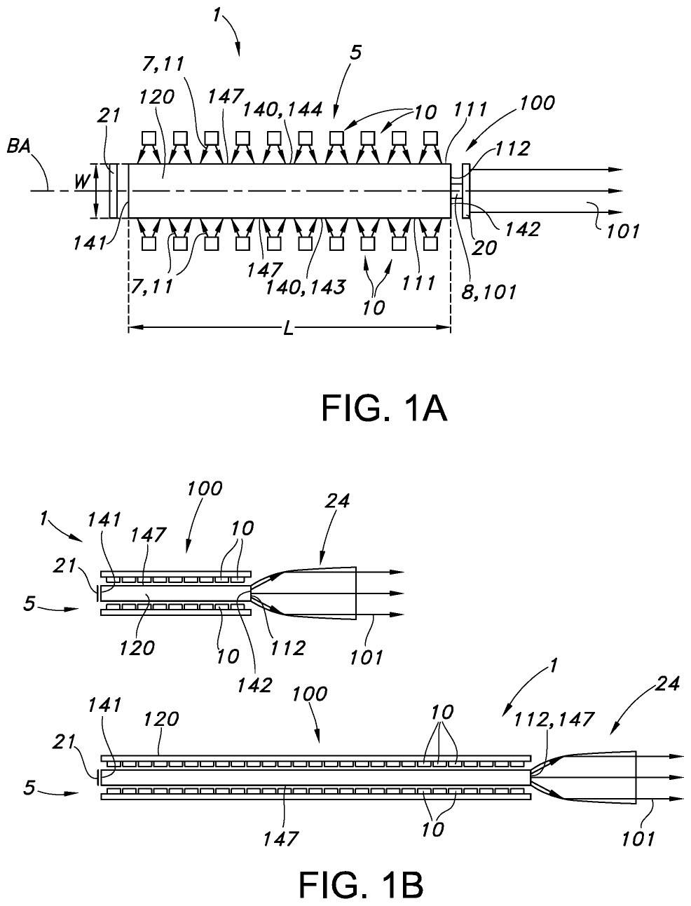

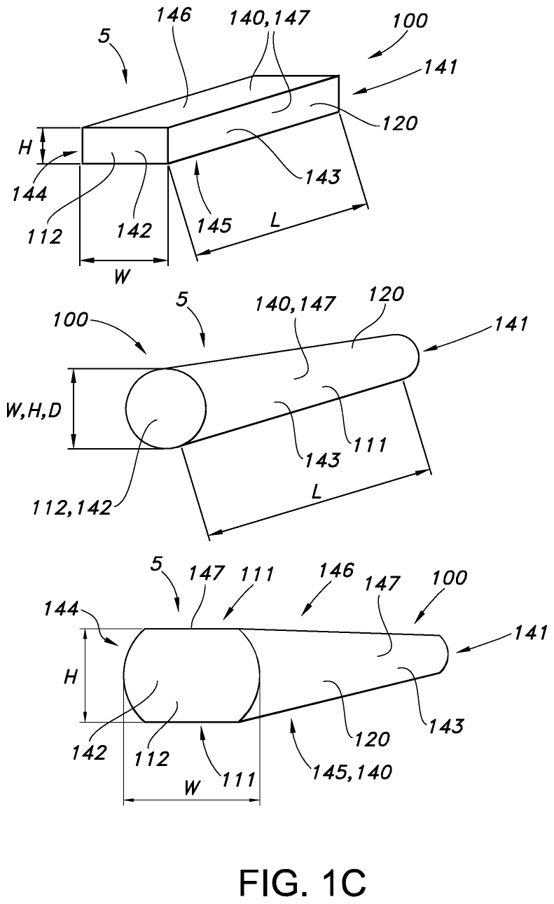

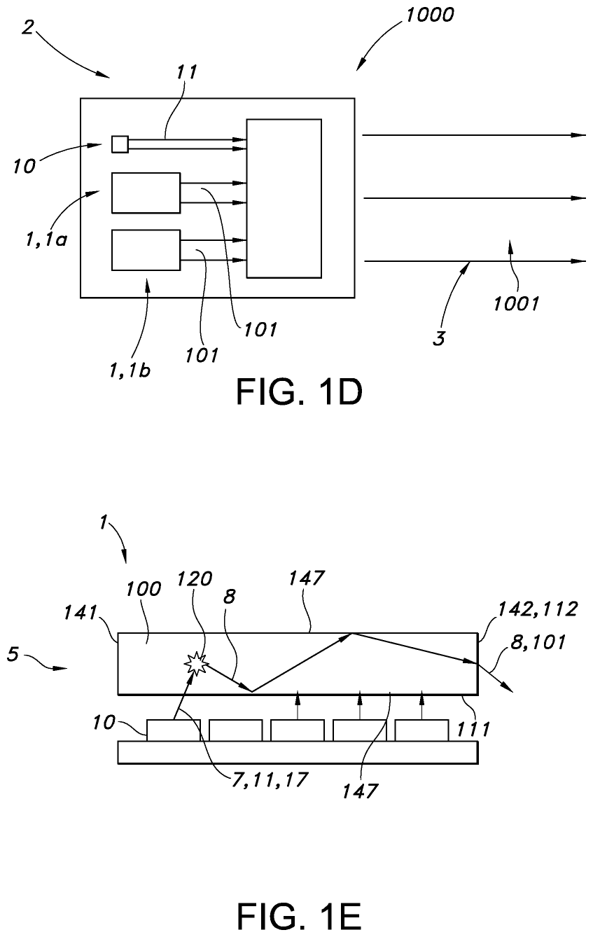

An embodiment of the lighting device as defined herein is schematically depicted in FIG. 1a. FIG. 1a schematically depicts a lighting device 1 comprising a plurality of solid state light sources 10 and a luminescent concentrator 5 comprising an elongated light transmissive body 100 having a first face 141 and a second face 142 defining a length L of the elongated light transmissive body 100. The elongated light transmissive body 100 comprising one or more radiation input faces 111, here by way of example two oppositely arranged faces, indicated with references 143 and 144 (which define e.g. the width W), which are herein also indicated as edge faces or edge sides 147. Further the light transmissive body 100 comprises a radiation exit window 112, wherein the second face 142 comprises said radiation exit window 112. The entire second face 142 may be used or configured as radiation exit window. The plurality of solid state light sources 10 are configured to provide (blue) light source light 11 to the one or more radiation input faces 111. As indicated above, they especially are configured to provide to at least one of the radiation input faces 111 a blue power Wₒₚₜ of in average at least 0.067 Watt/mm². Reference BA indicates a body axis, which will in cuboid embodiments be substantially parallel to the edge sides 147. Reference 140 refers to side faces or edge faces in general.

The elongated light transmissive body 100 may comprise a ceramic material 120 configured to wavelength convert at least part of the (blue) light source light 11 into converter light 101, such as at least one or more of green and red converter light 101. As indicated above the ceramic material 120 comprises an A₃B₅O₁₂:Ce³⁺ ceramic material, wherein A comprises e.g. one or more of yttrium (Y), gadolinium (Gd) and lutetium (Lu), and wherein B comprises e.g. aluminum (Al). References 20 and 21 indicate an optical filter and a reflector, respectively. The former may reduce e.g. non-green light when green light is desired or may reduce non-red light when red light is desired. The latter may be used to reflect light back into the light transmissive body or waveguide, thereby improving the efficiency. Note that more reflectors than the schematically depicted reflector may be used. Note that the light transmissive body may also essentially consist of a single crystal, which may in embodiments also be A₃B₅O₁₂:Ce³⁺.

The light sources may in principle be any type of point light source, but is in an embodiment a solid state light source such as a Light Emitting Diode (LED), a Laser Diode or Organic Light Emitting Diode (OLED), a plurality of LEDs or Laser Diodes or OLEDs or an array of LEDs or Laser Diodes or OLEDs, or a combination of any of these. The LED may in principle be an LED of any color, or a combination of these, but is in an embodiment a blue light source producing light source light in the UV and/or blue color-range which is defined as a wavelength range of between 380 nm and 490 nm. In another embodiment, the light source is an UV or violet light source, i.e. emitting in a wavelength range of below 420 nm. In case of a plurality or an array of LEDs or Laser Diodes or OLEDs, the LEDs or Laser Diodes or OLEDs may in principle be LEDs or Laser Diodes or OLEDs of two or more different colors, such as, but not limited to, UV, blue, green, yellow or red.

The light sources 10 are configured to provide light source light 11, which is used as pump radiation 7. The luminescent material 120 converts the light source light into luminescent material light 8 (see also FIG. 1e). Light escaping at the light exit window is indicated as converter light 101, and will include luminescent material light 8. Note that due to reabsorption part of the luminescent material light 8 within the luminescent concentrator 5 may be reabsorbed. Hence, the spectral distribution may be redshifted relative e.g. a low doped system and/or a powder of the same material. The lighting device 1 may be used as luminescent concentrator to pump another luminescent concentrator.

FIGS. 1a-1b schematically depict similar embodiments of the lighting device. Further, the lighting device may include further optical elements, either separate from the waveguide and/or integrated in the waveguide, like e.g. a light concentrating element, such as a compound parabolic light concentrating element (CPC). The lighting devices 1 in FIG. 1b further comprise a collimator 24, such as a CPC.

As shown in FIGS. 1a-1b and other Figures, the light guide has at least two ends, and extends in an axial direction between a first base surface (also indicated as first face 141) at one of the ends of the light guide and a second base surface (also indicated as second face 142) at another end of the light guide.

FIG. 1c schematically depicts some embodiments of possible ceramic bodies or crystals as waveguides or luminescent concentrators. The faces are indicated with references 141-146. The first variant, a plate-like or beam-like light transmissive body has the faces 141-146. Light sources, which are not shown, may be arranged at one or more of the faces 143-146 (general indicated of the edge faces is reference 147). The second variant is a tubular rod, with first and second faces 141 and 142, and a circumferential face 143. Light sources, not shown, may be arranged at one or more positions around the light transmissive body. Such light transmissive body will have a (substantially) circular or round cross-section. The third variant is substantially a combination of the two former variants, with two curved and two flat side faces. The variants shown in FIG. 1c are not limitative. More shapes are possible; i.e. for instance referred to WO2006/054203, which is incorporated herein by reference. The ceramic bodies or crystals, which are used as light guides, generally may be rod shaped or bar shaped light guides comprising a height H, a width W, and a length L extending in mutually perpendicular directions and are in embodiments transparent, or transparent and luminescent. The light is guided generally in the length L direction. The height H is in embodiments <10 mm, in other embodiments <5 mm, in yet other embodiments <2 mm. The width W is in embodiments <10 mm, in other embodiments <5 mm, in yet embodiments <2 mm. The length L is in embodiments larger than the width W and the height H, in other embodiments at least 2 times the width W or 2 times the height H, in yet other embodiments at least 3 times the width W or 3 times the height H. Hence, the aspect ratio (of length/width) is especially larger than 1, such as equal to or larger than 2, such as at least 5, like even more especially in the range of 10-300, such as 10-100, like 10-60, like 10-20. Unless indicated otherwise, the term “aspect ratio” refers to the ratio length/width. FIG. 1c schematically depicts an embodiment with four long side faces, of which e.g. two or four may be irradiated with light source light.

The aspect ratio of the height H:width W is typically 1:1 (for e.g. general light source applications) or 1:2, 1:3 or 1:4 (for e.g. special light source applications such as headlamps) or 4:3, 16:10, 16:9 or 256:135 (for e.g. display applications). The light guides generally comprise a light input surface and a light exit surface which are not arranged in parallel planes, and in embodiments the light input surface is perpendicular to the light exit surface. In order to achieve a high brightness, concentrated, light output, the area of light exit surface may be smaller than the area of the light input surface. The light exit surface can have any shape, but is in an embodiment shaped as a square, rectangle, round, oval, triangle, pentagon, or hexagon.

Note that in all embodiments schematically depicted herein, the radiation exit window is especially configured perpendicular to the radiation input face(s). Hence, in embodiments the radiation exit window and radiation input face(s) are configured perpendicular. In yet other embodiments, the radiation exit window may be configured relative to one or more radiation input faces with an angle smaller or larger than 90°.

FIG. 1d very schematically depicts a projector or projector device 2 comprising the lighting device 1 as defined herein. By way of example, here the projector 2 comprises at least two lighting devices 1, wherein a first lighting device (la) is configured to provide e.g. green light 101 and wherein a second lighting device (1b) is configured to provide e.g. red light 101. Light source 10 is e.g. configured to provide blue light. These light sources may be used to provide the projection (light) 3. Note that the additional light source 10, configured to provide light source light 11, is not necessarily the same light source as used for pumping the luminescent concentrator(s). Further, here the term “light source” may also refer to a plurality of different light sources. The projector device 2 is an example of a lighting system 1000, which lighting system is especially configured to provide lighting system light 1001, which will especially include lighting device light 101.

High brightness light sources are interesting for various applications including spots, stage-lighting, headlamps and digital light projection.

For this purpose, it is possible to make use of so-called light concentrators where shorter wavelength light is converted to longer wavelengths in a highly transparent luminescent material. A rod of such a transparent luminescent material can be used and then it is illuminated by LEDs to produce longer wavelengths within the rod. Converted light which will stay in the luminescent material such as a doped garnet in the waveguide mode and can then be extracted from one of the surfaces leading to an intensity gain (FIG. 1e).

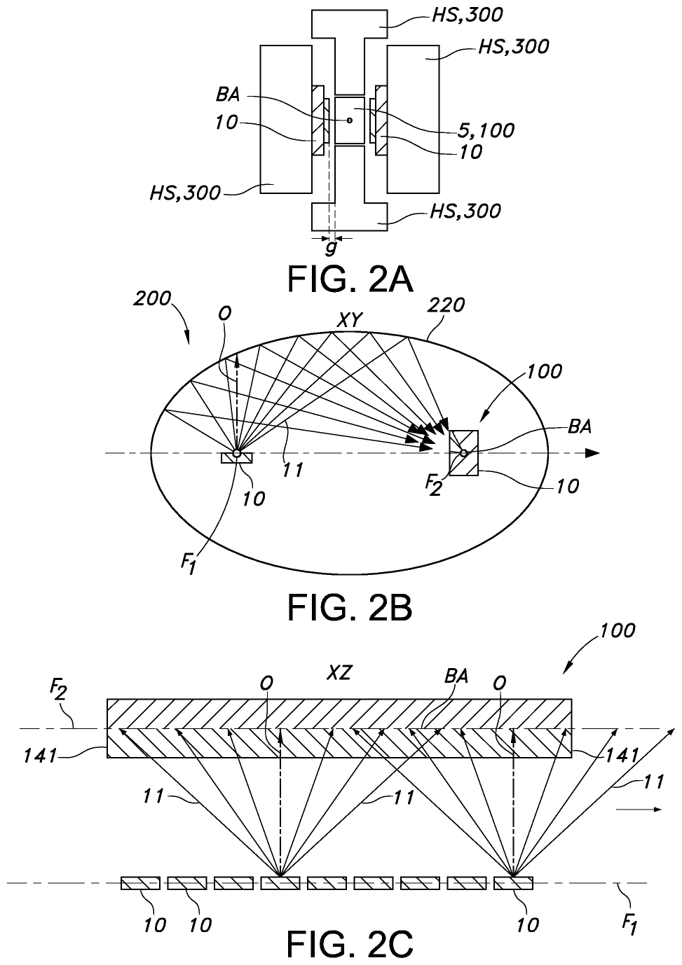

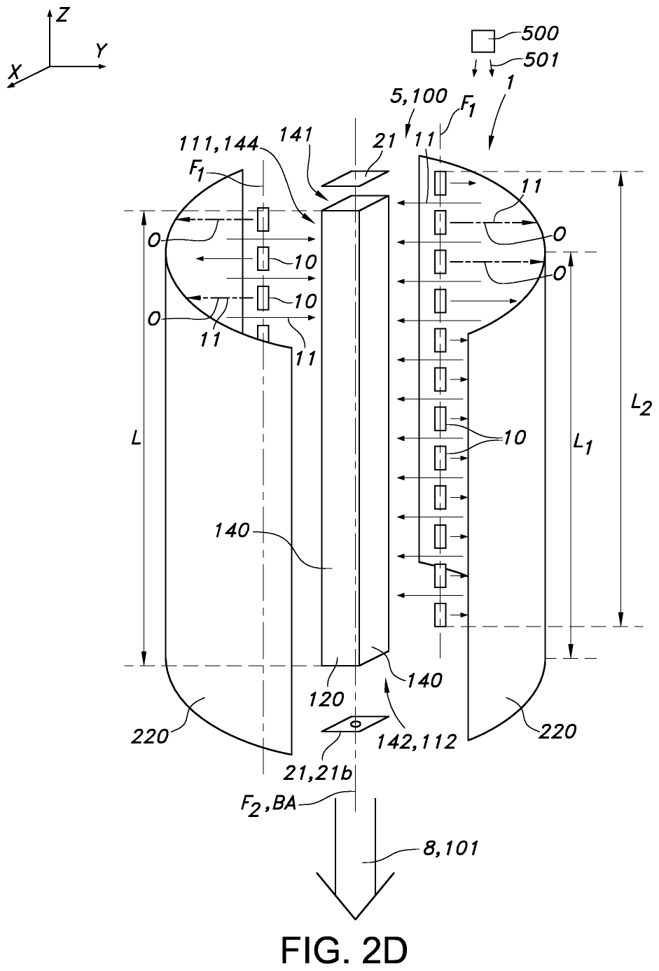

High-brightness LED-based light source for beamer applications appear to be of relevance. For instance, the high brightness may be achieved by pumping a luminescent concentrator rod by a discrete set of external blue LEDs, whereupon the phosphor that is contained in the luminescent rod subsequently converts the blue photons into green or red photons. Due to the high refractive index of the luminescent rod host material (typically 1.8) the converted green or red photons are almost completely trapped inside the rod due to total internal reflection. At the exit facet of the rod the photons are extracted from the rod by means of some extraction optics, e.g. a compound parabolic concentrator (CPC), or a micro-refractive structure (micro-spheres or pyramidal structures). As a result the high luminescent power that is generated inside the rod can be extracted at a relatively small exit facet, giving rise to a high source brightness. Currently the LED modules used for pumping the luminescent rods are in close contact with the rods in order to couple in as much light as possible, as depicted in FIG. 2a. In this concept the air gap g between the individual LED dies and the luminescent rod is kept as small as possible (tens to a few hundred micrometers) in order to couple in as much light into the rod as possible. In a practical implementation, typically 0.3 min distance is used. Putting more LEDs around the luminescent rod in order to increase pumping power is not possible since all available space is occupied in this concept for the given rod size. Reference 300 refers to a cooling element; reference HS indicates a heatsink. Here, a plurality of heatsinks are applied for thermal management of the light source(s) 10 and of the light transmissive body 100.

In this invention a method for remote pumping of a luminescent concentrator rod is used in embodiments by using the combination of (i) elliptical mirrors and (ii) pre-collimation and pre-tilting of the discrete LED-sources. The main idea about using an elongated elliptical mirror is rather straightforward: when placing a light source (i.e. the LED) into one focal line of an ellipse, the light will be redirected towards the second focal line (i.e. the luminescent rod). When placing an array of LEDs along the first focal line, an elongated focus will be created along the second focal line. This (astigmatic) focusing is illustrated in FIGS. 2b-2c. However, since the elliptical mirror has focusing strength in only one plane (the plane of the ellipse), the direction vector of the light rays out of this focusing plane will be unaltered and may ultimately miss the luminescent rod, as indicated by the two most right-handed light rays in FIG. 2c. Further optical arrangements are suggested that can further optimize the collection efficiency of this elliptical pumping concept for our luminescent rods. F1 and F2 schematically indicate the first and second focus, respectively.

As schematically shown in FIG. 2b, in embodiments the optical axis of the light source is not directed to the light transmissive body 100 but to curved the mirror, which is indicated with reference 220 (of a mirror unit 200). Hence, the light source 10 is configured to provide the light source light 11 in a direction of the curved mirror 220. Especially, in embodiments herein, at least part of the light source light, such as at least 50%, like at least 80%, such as at least 90%, such as in embodiments (essentially) all light source light is received by the curved mirror 220, and part thereof, after at least one reflection at the curved mirror 220 may reach the light transmissive body 100. Hence, in embodiments at least 50%, like at least 80%, such as at least 90%, such as in embodiments (essentially) all light source light that is received by the light transmissive body 100 is only received after a reflection at the curved mirror 220. Hence, for an essential part of the light source light received at the light transmissive body 100, the curved mirror 220 is in fact configured upstream of the light transmissive body 100 and the light source 10 is configured upstream of the curved mirror 220. Hence, in embodiments the optical axis, indicated with reference O, may not direct to the light transmissive body (but to the curved mirror 220).

The light transmissive body 100 is especially an elongated light transmissive body.

Reference 2d schematically depicts a perspective view of an embodiment of the device 1, where with two mirror units 200, each having a length L1, substantially identical to the length L of the light transmissive body 100. The light sources 10 are configured in a row having a length L2, also being substantially identical to the length L of the light transmissive body 100. The light sources 10 are especially configured in the first focus or focal line F1 and the second focus/focal lines F2 may coincide with the light transmissive body 100. Note that the second focus/focal lines F2 do not necessarily coincide at the light transmissive body 100 but may also be configured parallel, e.g. at respective radiation input faces 111. Especially, the (elongated) curved mirror has a mirror length L1 in the range of 80-120% of the length of row of light sources, which length is indicated with reference L2. The mirrors 220 as schematically depicted in FIG. 2d may substantially have the shape of an elliptical cylinder segment (i.e. segment of an elliptical cylinder). Note that each cross section perpendicular to an axis of elongation of the mirror 220 may provide such half ellipse shape.

Referring to FIG. 2d, at one side a single curved mirror 220 is depicted. In yet other embodiments, such as especially over substantially the same length L1, two or more curved mirrors 220 may be configured (in series). Hence, the term, the light source mirror unit may include a plurality of curved mirrors, such as configured one next to the other to form an elongated mirror (having a substantially the length L1).

Optionally, also at the second face 142 a mirror 21 may be configured, such as a mirror with a hole 21b such that light may escape through the hole and reflected light may be reflected back in the elongated body. This mirror 21, or these mirrors 21, may not be in physical contact with the second (or first) face, but may be configured close to the second (or first0 face, such as at a distance of 0.1-1 mm, like 0.1-0.5 mm.

Reference 500 schematically indicates a gas, especially air, displacement unit, configured to provide a flow 501 of gas between the elongated body 100 and the light sources 10 and/or mirrors 220. In this way, a further cooling may be obtained.

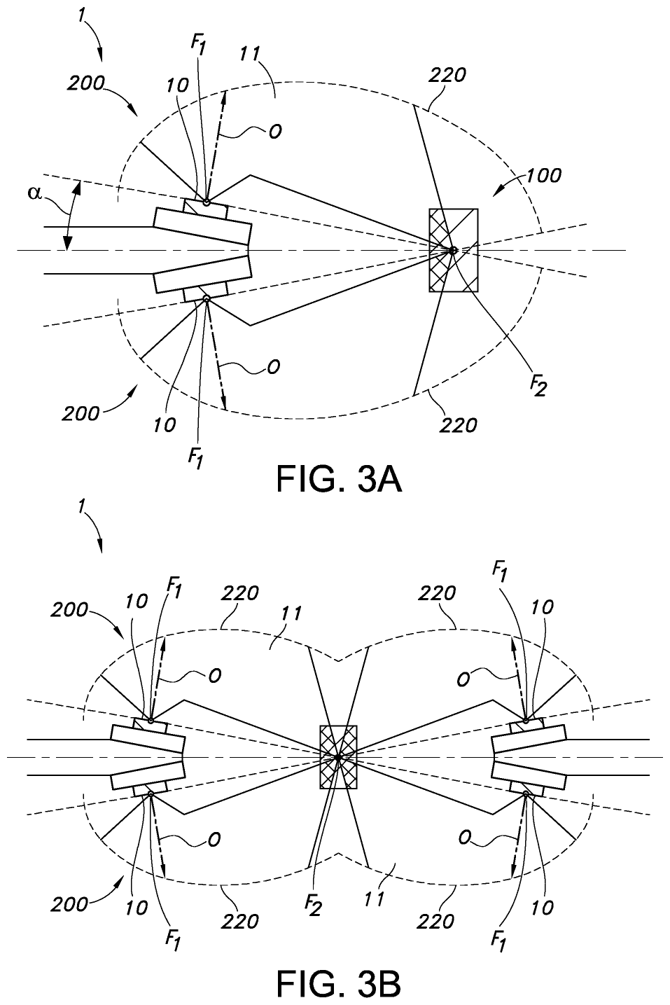

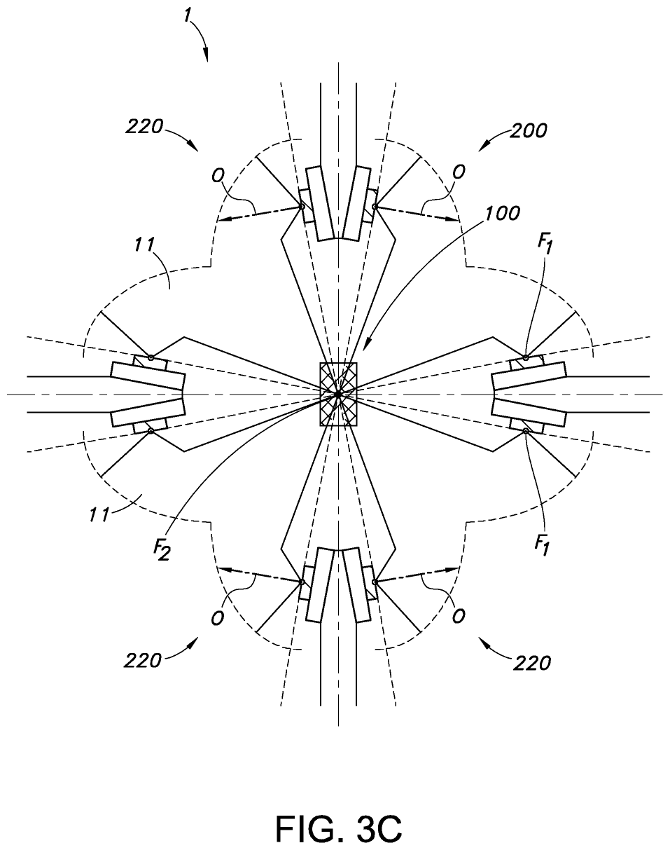

By using multiple elliptical mirrors, a most effective remote optical pumping arrangement can be obtained for the light concentrator device. This may be combined with pre-collimation and pre-tilting of the individual LED outputs (see below). Several arrangements are depicted in FIGS. 3a-3c.

FIG. 3a shows an arrangement where two elongated half-elliptical mirrors are being used in order to collimate the output of two LED strips emitting in opposite directions. One of the the two focal points of the two half-ellipses coincides with the center of the rod entrance face, whereas the other focal points of the two half-ellipses coincide with the center of the respective LED modules. As a result, the long axes of both half-ellipses may make a certain angle with respect to each other, αₑₗₗᵢₚₛₑ (indicated in the drawing with a), depending on the thickness of the LED module and the intermediate heatsink. Since the angular dependence of the emission of the LEDs is in forward directions (e.g. Lambertian), an optimal αₑₗₗᵢₚₛₑ can be found to maximize the amount of light reaching the rod.

In principle the whole 2a upper (and lower) half space can be used for collection and focusing of light from the two LED modules. In practice however the luminescent rod needs to be mechanically clamped for positioning and cooling purposes. As a result only part of the 2 α upper (and lower) half space will be accepted by the elliptical mirrors, the rest of the light will be lost or scattered into the mirror cavity. This “dead angle” strongly depends on the ratio between of the long and short axes of the ellipse and can be minimized accordingly. The dead angle would be minimum for very elongated (large eccentricity) ellipses; however, in this case optical aberrations will strongly enlarge the spot at the position of the luminescent rod. An optimum can be found here depending on the LED light output angular distribution, dimensions of the LED-die, rod size and ellipse geometry. In FIG. 3a, the mirror(s) 220 are curved mirrors that may substantially have an elliptical shape, or which curvature substantially follows the curvature of a curved part of an elliptical shape. Here, embodiments are schematically depicted wherein the mirrors may comprise segments of ellipses, especially half-ellipses (half-elliptical mirrors).

FIG. 3b shows an arrangement with 4 elongated truncated elliptical mirrors. Due to symmetry considerations the amount of light coupled into the luminescent rod is substantially twice the amount obtained by the geometry of FIG. 3a (assuming four instead of two identical LED arrays and assuming no contribution from rays that hit the rod via the other elliptical mirror).

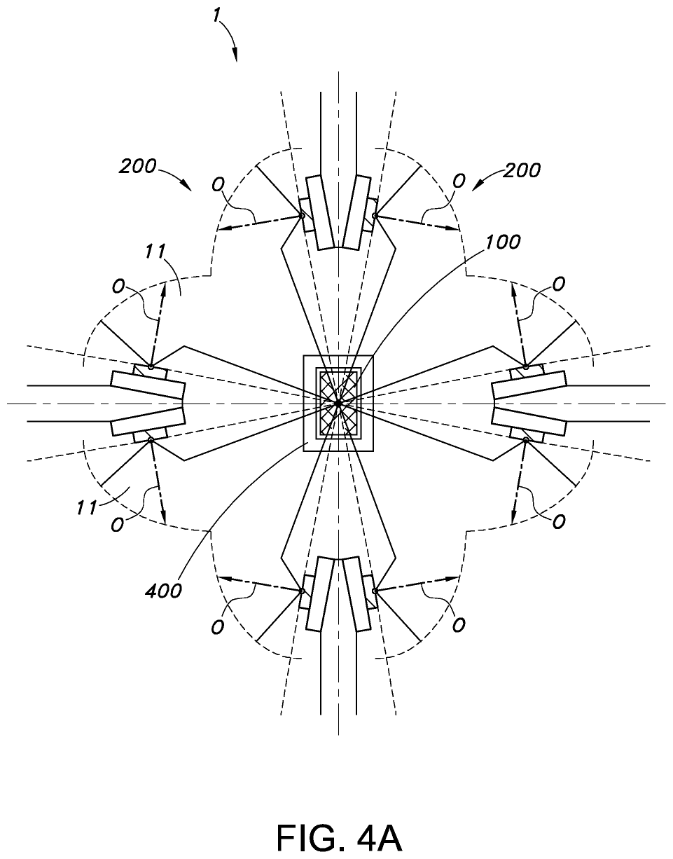

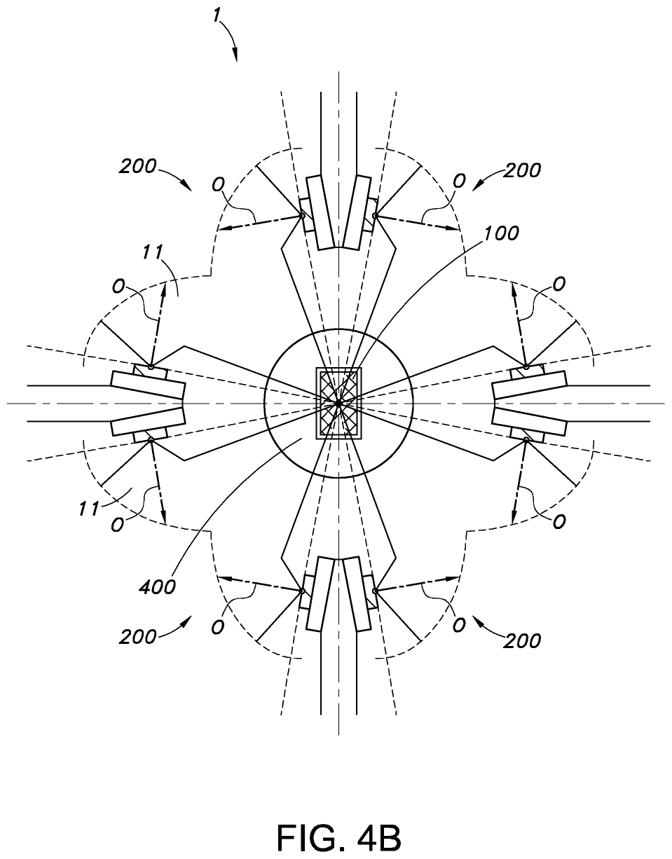

In FIG. 3c an arrangement is shown with eight elongated truncated elliptical mirrors. Since the above mentioned dead angle is larger in this case, the collection efficiency of each individual ellipse is smaller as in FIGS. 4a and 4b. Although still more light might be coupled into the luminescent rod (since the amount of LED arrays doubles), the expected overall collection efficiency of this arrangement may be smaller than for the arrangements in FIGS. 4a and 4b. Moreover, also the luminescent rod should be mechanically clamped and cooled. In the arrangement of FIG. 3c, there is less room for this.

A solution may be to apply an air flow inside the arrangement to cool the rod. An inlet may be applied in the assembly and an outlet to direct the airflow inside and outside respectively. The airflow may be originating from a (small) fan, such as the above indicated air displacement unit. In such a configuration the rod may also be supported at a few locations, hanging substantially in free space.

However, in the various configurations of FIGS. 3a-3c, the rod may be contacted and cooled within the dead zones of the elliptical mirror configurations. This may be done by clamping the rod in between a cooling block, typically a metal shape, for instance made from copper or aluminium. Also, the LED/elliptical mirror configuration in FIGS. 3a-3c may be rotated with respect to the rod at varying angles. In other words, in FIGS. 3a-3c the rod may be rotated at various angles compared to the depicted direction of the rod.

Hence, FIGS. 3a, 3b, 3c schematically depict embodiments comprising 2, 4 and 8 light source mirror units, respectively.

Another opportunity to cool the rod when illuminated from all sides is to mold a non-luminescent transparent ceramic cooling envelop (400) around the rod. If the ceramic envelope is molded from a suitable ceramic, such as YAG, the envelope can be made fully transparent without disturbing the optical light path. The cooling envelope has a relatively high thermal conductivity and thus aids to spread out the heat. The envelope may be contacted at various locations that are not within the optical path by non-transparent heat conducting materials, such as copper to allow proper heatsinking. The cooling envelope surfaces may be polished. The extra refractions at the cooling envelope may be taken into account in the design of the optical path. It is required that the cooling envelop may hold and support the rod at some locations but is not in optical contact to the rod in order to maintain light guiding within the rod. Hence, a thin effective airgap is present between the rod and transparent cooling envelope. As such, the shape of the inner surface of the cooling envelope is similar to the shape of the luminescent concentrator but slightly larger. The cross-sectional outer shape of the cooling envelope may deviate and consist of many shapes, for instance rectangular or round. Examples of these embodiments are schematically depicted in FIGS. 4a-4b. The envelope is indicated with reference 400. A small air gap is schematically draw in FIGS. 4a and 4b. note that in FIG. 4a the shape of the envelope 400 is substantially the same as the elongated body 100, whereas in FIG. 4b the shapes are different.

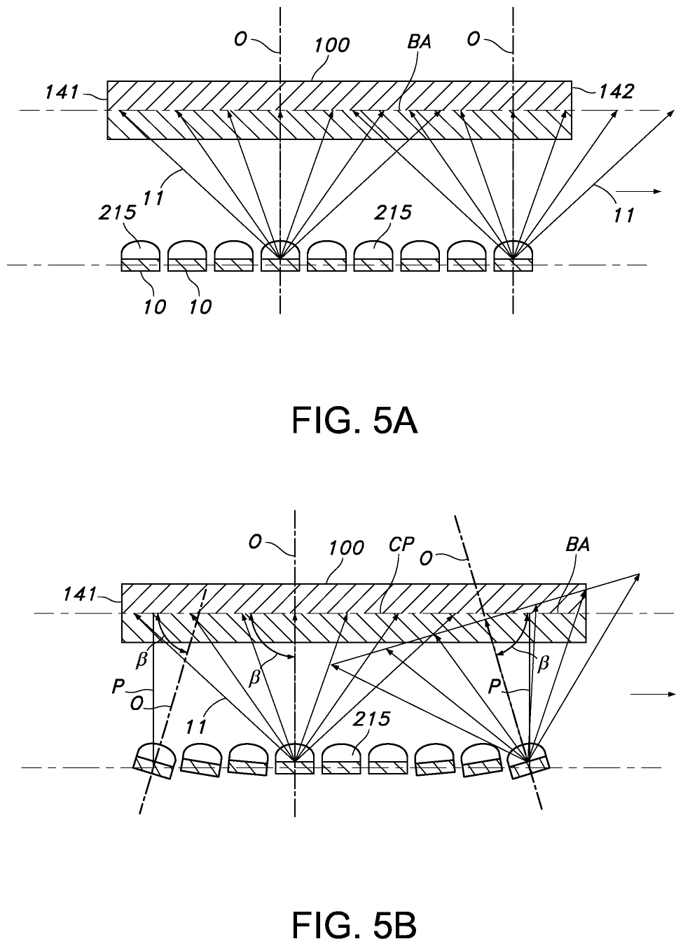

In order to collect and redirect light as much as possible towards the second focal line, the output from the individual LEDs may be pre-collimated (in the XZ direction) by an additional (cylindrical) optics. As a result the divergence angle of the light beam emitted by the individual LEDs (in the YZ plane) becomes smaller and less light is wasted at the two distant rod edges. This is illustrated in FIG. 5a. The light emitted by the distant LED modules can be even better directed towards the luminescent rod by slightly pre-tilting the LEDs with respect to the long axis of the luminescent rod. This is illustrated in FIG. 5b. This also works without pre-collimation since the angular dependence of the emission of an LED is in forward directions (e.g. Lambertian). The angle between the optical axis O and the body axis BA is indicated with β. This angle β may be about 90°, or smaller, such as down to about 35°, such as 45° close the the first face 141 and/or second face 142. The angle β is the smallest angle. Note that the angle β may be comprised by a triangle defined by a normal P (perpendicular) to the body axis BA and connecitng the light source 10 and the body axis BA, the optical axis O of the light 11 of the same light source 10 and the body axis BA.

Another way to ensure that the light does not miss the rod, is to provide mirrors at the left and right sides of the rod and LED arrays (see also above).

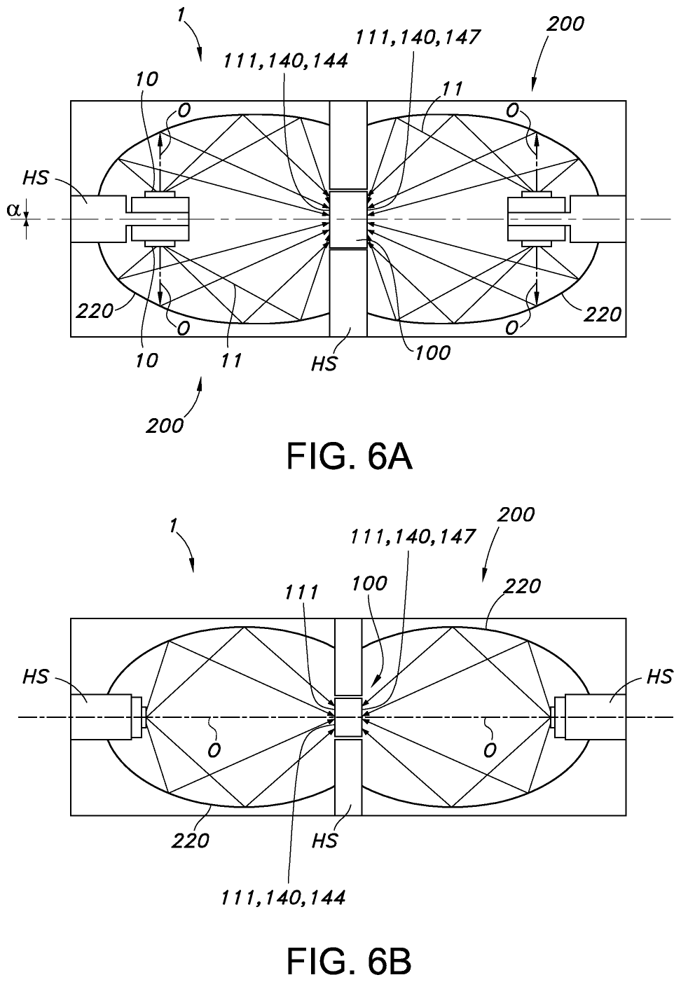

Below, some specific embodiments are shown and described. FIG. 6a schematically depicts a configuration with high light output. Side mirrors can be present parallel to the plane of drawing (i.e. parallel to the first face 141 and/or second face 142, respectively (faces 141,142 not indicated in this drawing). FIG. 6b. schematically depicts substantially the same configuration but with 1 LED strip per side. In another variant to FIG. 6b the LED strip consists of side-emitting LEDs directing more light upwards and downwards to interact with the curved mirror.

For the configuration with 4 LED strips and two (half) ellipses (FIG. 6a) with side mirrors, we first performed ray-trace simulations omitting the clamping blocks. If also the room needed to hold (and cool) the LEDs are omitted, an efficiency of 83% was found, i.e. 83% of the photons emitted by the LEDs reach the luminescent rod. With realistic block dimensions for clamping the LEDs, this number drops to 74%. If also the rod is clamped at the full area of the short side faces (as shown in FIG. 6a), the efficiency is only 62%, since the small sides cannot be used. In this examples the LEDs are not pre-tilted. Moreover, light from the LEDs at the left side can no longer reach the right side of the rod or vice versa.

It is also possible to use only 1 LED strip at each side (FIG. 6b). Then the best configuration is to direct the emitting side to the rod, resulting in an efficiency of 90%. In FIGS. 6a and 6b, but also in other figures, the mirrors 220 comprise parts of ellipses. However, especially or parts of elliptically shaped elements. Especially, the curved mirrors are configured such, that two foci (especially including two focal lines or two focal faces or two focal volumes) are obtained. Note that in FIG. 6a αₑₗₗᵢₚₛₑ (i.e. α) is substantially equal to zero.

Hence, the invention may e.g. provide a concentrating light source, consisting of a conversion structure that absorbs light from one or more arrays of LEDs, with a curved mirror around it that focuses the LED light onto the conversion structure. Further, the invention may provide such concentrating light source, where a the cross-section of the curved mirror has a shape consisting of 1 or more ellipses, where both the conversion structure and the LED strips are as close as possible to the focus points of the ellipse(s). Further, the invention may provide such concentrating light source, where the cross-section of the curved mirror has a shape consisting of two ellipses, where both the conversion structure and the LED strips are as close as possible to the focus points of the ellipses. Further, the invention may provide such concentrating light source, containing side mirrors perpendicular to the long sides of the rod and to the LED strips. Especially one of the side mirrors may be configured as end mirror (such as end mirror 21, see amongst others FIGS. 1a, 1b, and 2d). Further, the invention may provide such concentrating light source containing clamping and cooling devices for LEDs and conversion structure. Further, the invention may provide such concentrating light source, where the individual LEDs are tilted such that the amount of LED light arriving at the conversion structure is maximized.

Applications include but are not limited to projectors, lamps, luminaires, or other lighting systems such as shop lighting systems, home lighting systems, accent lighting systems, spot lighting systems, theater lighting systems, fiber-optics application systems, projection systems, display systems, warning sign systems, medical lighting application systems, indicator sign systems, and decorative lighting systems, portable systems and automotive applications.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A lighting device comprising:
a luminescent concentrator comprising an elongated light transmissive body having a first face and a second face defining a length of the light transmissive body, the light transmissive body comprising one or more radiation input faces and a radiation exit window wherein the second face comprises said radiation exit window; the elongated light transmissive body comprising a luminescent material configured to convert at least part of light source light received at one or more radiation input faces into luminescent material light, and the luminescent concentrator configured to couple at least part of the luminescent material light out at the radiation exit window as converter light;
a light source mirror unit comprising:
a plurality of light sources configured to provide said light source light in a direction of a curved mirror;
said curved mirror, configured to collect at least part of said light source light and configured to redirect the collected light source light to at least one of the one or more the radiation input faces of the luminescent concentrator;
wherein the lighting device comprising a plurality of light source mirror units in the range of two to eight, wherein the elongated light transmissive body comprises two or more side faces, wherein two or more mirror units are configured to provide the light source light of the respective light sources to two or more different side faces, and
wherein the curved mirror has an elliptical shape having a first focus and a second focus, wherein the light sources have light emitting surfaces, wherein one or more light emitting surfaces are configured at the first focus and wherein the elongated light transmissive body is configured at the second focus.

2. The lighting device according to claim 1, further comprising a cooling element in thermal contact with the luminescent concentrator.

3. The lighting device according to claim 1, wherein the two or more side faces comprise one or more radiation input faces, wherein the light source unit is configured to provide said light source light to a first part of the two or more side faces, the lighting device further comprising a cooling element in thermal contact with the luminescent concentrator, wherein the cooling element is in thermal contact with a second part of the two or more side faces.

4. The lighting device according to claim 1, wherein the light sources are configured to provide light source light having an optical axis and wherein the optical axes of the light sources are directed to the curved mirror.

5. The lighting device according to claim 1, wherein the light sources are configured to provide light source light having an optical axis, wherein the elongated light transmissive body has a body axis, wherein one or more light sources are configured to provide said light source light with said optical axis perpendicular to the body axis and wherein one or more light sources are configured to provide said light source light with said optical axis having an angle smaller than 90° and equal to or larger than 45°.

6. The lighting device according to claim 1, wherein the light sources comprise solid state light sources having light emitting surfaces with downstream thereof collimators for a pre-collimation of the light source light.

7. The lighting device according to claim 1, wherein the elongated light transmissive body comprises an elongated ceramic or elongated crystal body.

8. The lighting device according to claim 1, wherein the elongated light transmissive body is at least partly enclosed by a light transmissive envelope, wherein the lighting device further comprises a cooling element in thermal contact with part of the light transmissive envelope.

9. The lighting device according to claim 1, wherein the curved mirror has a mirror length in the range of 80-120% of the length of the elongated light transmissive body wherein the curved mirror is configured parallel to the elongated light transmissive body.

10. The lighting device according to claim 1, having a mirror configured at the first face configured to reflect light back into the elongated light transmissive body, and having one or more of an optical filter, a wavelength selective mirror, light extraction structures, and a collimator configured at the second face and a second mirror configured at the second face.

11. The lighting device according to claim 10, wherein the two or more side faces comprise one or more radiation input faces, wherein two or more mirror units are configured to provide said light source light to one or more firsts parts of the two or more side faces, the lighting device further comprising a cooling element in thermal contact with the luminescent concentrator, wherein the cooling element is in physical contact with one or more second parts of the two or more side faces.

12. A lighting system configured to provide lighting system light, the lighting system comprising one or more lighting devices according to claim 1.

13. The lighting system according to claim 12, wherein the lighting system comprises a digital projector or a stage lighting system.
